(19) United States
(12) Patent Application Publication
(10) Pub. No.: US 2024/0224324 A1
(43) Pub. Date: Jul. 4, 2024

(54) APPARATUS AND METHOD IN WIRELESS COMMUNICATION SYSTEM

(71) Applicant: Samsung Electronics Co., Ltd., Suwon-si (KR)

(72) Inventors: Di SU, Beijing (CN); Chen QIAN, Beijing (CN); Peng LIN, Beijing (CN)

(21) Appl. No.: 18/501,568

(22) Filed: Nov. 3, 2023

(30) Foreign Application Priority Data
Dec. 30, 2022 (CN) 202211729630.3
May 10, 2023 (CN) 202310524817.8

(51) Int. Cl. H04W 74/08

(52) U.S. Cl. CPC H04W 74/0808

(57) ABSTRACT

The present disclosure relates to a 5G communication system or a 6G communication system for supporting higher data rates beyond a 4G communication system such as long term evolution (LTE). An apparatus and a method in a wireless communication system are provided. The method includes transmitting a physical signal, and determining resources associated with sensing detection based on the physical signal, where on the determined resources, one or more downlink signals are not received, and/or one or more uplink signals are not transmitted. This disclosure can improve communication efficiency.

### CROSS-REFERENCE TO RELATED APPLICATION(S)

This application is based on and claims priority under 35 U.S.C. § 119(a) of a Chinese patent application number 202211729630.3, filed on Dec. 30, 2022, in the China National Intellectual Property Administration, and of a Chinese patent application number 202310524817.8, filed on May 10, 2023, in the China National Intellectual Property Administration, the disclosure of each of which is incorporated by reference herein in its entirety.

### BACKGROUND

### 1. Field

The disclosure relates to the field of wireless communication. More particularly, the disclosure relates to sensing detection resources for joint sensing and communication in a wireless communication system.

### 2. Description of Related Art

Considering the development of wireless communication from generation to generation, the technologies have been developed mainly for services targeting humans, such as voice calls, multimedia services, and data services. Following the commercialization of 5^{th} generation (5G) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6^{th} generation (6G) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bit per second (bps) and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz (THz) band (for example, 95 gigahertz (GHz) to 3 THz bands). It is expected that, due to severer path loss and atmospheric absorption in the terahertz bands than those in millimeter wave (mmWave) bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple-input multiple-output (MIMO), full dimensional MIMO (FD-MIMO), array antennas, and multiantenna transmission technologies, such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems a full-duplex technology for enabling an uplink transmission and a downlink transmission to simultaneously use the same frequency resource at the same time, a network technology for utilizing satellites, high-altitude platform stations (HAPS), and the like in an integrated manner, an improved network structure for supporting mobile base stations and the like and enabling network operation optimization and automation and the like, a dynamic spectrum sharing technology via collision avoidance based on a prediction of spectrum usage, an use of artificial intelligence (AI) in wireless communication for improvement of overall network operation by utilizing AI from a designing phase for developing 6G and internalizing end-to-end AI support functions, and a next-generation distributed computing technology for overcoming the limit of user equipment (UE) computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. More particularly, it is expected that services, such as truly immersive extended Reality (XR), high-fidelity mobile hologram, and digital replica could be provided through 6G communication systems. In addition, services, such as remote surgery for security and reliability enhancement, industrial automation, and emergency response will be provided through the 6G communication system such that the technologies could be applied in various fields, such as industry, medical care, automobiles, and home appliances.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide sensing detection resources for joint sensing and communication in a wireless communication system.

Additional aspects will be set forth in part in the description which follows and, in part, will be apparent from the description, or may be learned by practice of the presented embodiments.

In accordance with an aspect of the disclosure, a method performed by a first node in a wireless communication system is provided. The method includes transmitting a physical signal, and determining resources associated with sensing detection based on the physical signal, where on the determined resources, one or more downlink signals are not received, and/or one or more uplink signals are not transmitted.

In some implementations, for example, the determining resources associated with sensing detection based on the physical signal includes determining a first resource for sensing detection, where on the first resource, one or more downlink signals are not received. The determining a first resource for sensing detection includes receiving configuration information indicating the first resource for sensing detection from a second node.

In some implementations, for example, the configuration information indicates one or more of positions of time domain resource units for sensing detection, a number of time domain resource units for sensing detection, a period for sensing detection, positions of time domain resource units for sensing detection in a single period, a number of time domain resource units for sensing detection in a single period, positions of frequency domain resource units for sensing detection, a frequency hopping configuration of frequency domain resource units for sensing detection, wherein the time domain resource unit includes one or more of a time domain symbol, a slot, or a radio frame, and the frequency domain resource unit includes one or more of a subcarrier, a physical resource block, or a physical resource block group.

In some implementations, for example, the determining resources associated with sensing detection based on the physical signal includes determining a first resource for sensing detection, where on the determined first resource, one or more downlink signals are not received. The determining a first resource for sensing detection includes determining the first resource based on an association between the first resource and resources of the physical signal.

In some implementations, for example, the determining the first resource based on an association between the first resource and resources of the physical signal includes determining the first resource based on one or more of positions of one or more time domain resource units of the first resource being the same as positions of one or more time domain resource units the physical signal, there being a time interval between the positions of the one or more time domain resource units of the first resource and the positions of the one or more time domain resource units of the physical signal, frequency domain resources of the first resource including at least frequency domain resources of the physical signal, the frequency domain resources of the first resource being the same as the frequency domain resources of the physical signal, positions of one or more frequency domain resource units of the first resource being the same as positions of one or more frequency domain resource units of the physical signal, or the frequency domain resources of the first resource including the frequency domain resources of the physical signal and a frequency range of the first resource including at least a frequency range of the frequency domain resources of the physical signal.

In some implementations, for example, the method further includes receiving an echo signal for the physical signal on the determined first resource.

In some implementations, for example, the determining resources associated with sensing detection based on the physical signal includes determining a second resource on which one or more uplink signals are not transmitted. The determining a second resource includes determining the second resource based on an association between the second resource and resources of the physical signal.

In some implementations, for example, the determining the second resource based on an association between the second resource and resources of the physical signal includes determining the second resource based on one or more of there being a time interval between positions of one or more time domain resource units of the second resource and positions of one or more time domain resource units of the physical signal, frequency domain resources of the second resource being adjacent to the frequency domain resources of the physical signal.

In some implementations, for example, the one or more downlink signals include one or more of a downlink sensing-dedicated signal, a downlink shared channel associated with a specific radio network temporary identifier (RNTI), a downlink control channel, a downlink control channel associated with the specific RNTI, a downlink control channel in a UE-specific search space (USS), a downlink control channel in a common search space (CSS), a channel state information reference signal (CSI-RS), a synchronization signal, a physical broadcast channel (PBCH), or a synchronization signal block (SSB). For example, the association between the downlink shared channel and the specific RNTI includes one or more of the following: a scrambling sequence of the downlink shared channel being generated according to the specific RNTI, the downlink shared channel being scheduled by specific downlink control information scrambled by the specific RNTI (for example, specific downlink control information with a cyclic redundancy check (CRC) scrambled by the specific RNTI). For example, the association between the downlink control channel and the specific RNTI includes that the downlink control information is scrambled by the specific RNTI (for example, the downlink control information is with a CRC scrambled by the specific RNTI). For example, the specific RNTI includes one or more of a cell (C)-RNTI, a configuration scheduling (CS)-RNTI, a modulation and coding scheme (MCS)-C-RNTI, a system information (SI)-RNTI, a paging (P)-RNTI, a random access (RA)-RNTI, an MSGB-RNTI, a sensing-related RNTI, or all RNTIs except the sensing-related RNTI.

In some implementations, for example, the one or more uplink signals include one or more of an uplink sensing-dedicated signal, an uplink shared channel associated with a specific RNTI, an uplink control channel format 0, an uplink control channel format 1, an uplink control channel format 2, an uplink control channel format 3, uplink control channel format 4, a random access channel, a demodulation reference signal for the uplink shared channel, a demodulation reference signal for the uplink control channel, a phase tracking reference signal, or a sounding reference signal. For example, the association between the uplink shared channel and the specific RNTI includes one or more of the following a scrambling sequence of the uplink shared channel being generated according to the specific RNTI, the uplink shared channel is scheduled by specific downlink control information scrambled by the specific RNTI (for example, specific downlink control information with a CRC scrambled by the specific RNTI). For example, the specific RNTI includes one or more of the following: a cell (C)-RNTI, a configuration scheduling (CS)-RNTI, a modulation and coding scheme (MCS)-C-RNTI, a temporary cell (TC)-RNTI, a semi-persistent channel state information (SP-CSI)-RNTI, or a sensing-related RNTI, or all RNTIs except the sensing-related RNTI.

In some implementations, for example, the method further includes transmitting to a second node information indicating a demand for a distance from an object of the sensing detection, and/or information indicating a capability in relation to the sensing detection.

In accordance with another aspect of the disclosure, a method performed by a first node in a wireless communication system is provided. The method includes determining resources associated with sensing detection by a second node, where on the determined resources, one or more downlink signals are not received, and/or one or more uplink signals are not transmitted.

In some implementations, for example, the determining resources associated with sensing detection by a second node includes determining a third resource for sensing detection by the second node, where on the third resource, one or more uplink signals are not transmitted. The determining a third resource for sensing detection by the second node includes receiving configuration information from the second node, where the configuration information indicates the third resource for sensing detection by the second node.

In some implementations, for example, the configuration information indicates one or more of positions of time domain resource units for sensing detection by the second node, a number of time domain resource units for sensing detection by the second node, a period for sensing detection by the second node, positions of time domain resource units for sensing detection by the second node in a single period, a number of time domain resource units for sensing detection by the second node in a single period, positions of frequency domain resource units for sensing detection by the second node, a frequency hopping configuration of frequency domain resource units for sensing detection by the second node, where the time domain resource unit includes one or more of a time domain symbol, a slot, or a radio frame, and the frequency domain resource unit includes one or more of a subcarrier, a physical resource block, or a physical resource block group.

In some implementations, for example, the determining resources associated with sensing detection by a second node includes determining a third resource for sensing detection by the second node, where on the third resource, one or more uplink signals are not transmitted, and where the determining a third resource for sensing detection by the second node includes determining the third resource based on an association between the third resource and resources of the physical signal, where the sensing detection by the second node is based on the physical signal.

In some implementations, for example, the third resource is determined based on one or more of positions of one or more time domain resource units of the third resource being the same as positions of one or more time domain resource units of the physical signal, there being a time interval between the positions of the one or more time domain resource units of the time domain resource of the third resource and the positions of the one or more time domain resource units of the time domain resource of the physical signal, frequency domain resources of the third resource including at least frequency domain resources of the physical signal, the frequency domain resources of the third resource being the same as the frequency domain resources of the physical signal, positions of one or more frequency domain resource units of the third resource being the same as positions of one or more frequency domain resource units of the physical signal, or the frequency domain resources of the third resource including the frequency domain resources of the physical signal and having a frequency range wider than a frequency range of the frequency domain resources of the physical signal. The time domain resource unit includes one or more of a time domain symbol, a slot, or a radio frame, and the frequency domain resource unit includes one or more of a subcarrier, a physical resource block, or a physical resource block group.

In some implementations, for example, the determining resources associated with sensing detection by a second node includes determining a fourth resource, where on the fourth resource, one or more downlink signals are not received. The determining the fourth resource includes determining the fourth resource based on an association between the fourth resource and resources of the physical signal, where the sensing detection by the second node is based on the physical signal.

In some implementations, for example, the determining the fourth resource based on an association between the fourth resource and resources of the physical signal includes determining the fourth resource based on one or more of there being a time interval between positions of one or more time domain resource units of the fourth resource and positions of one or more time domain resource units of the physical signal, one or more frequency domain resource units of the fourth resource being adjacent to the first frequency domain resource unit or the last frequency domain resource unit of the one or more frequency domain resource units of the physical signal.

In some implementations, for example, the one or more downlink signals include one or more of a downlink sensing-dedicated signal, a downlink shared channel associated with a specific radio network temporary identifier (RNTI), a downlink control channel, a downlink control channel associated with the specific RNTI, a downlink control channel in a UE-specific search space (USS), a downlink control channel in a common search space (CSS), a channel state information reference signal (CSI-RS), a synchronization signal, a physical broadcast channel (PBCH), or a synchronization signal block (SSB), where the specific RNTI includes one or more of a cell (C)-RNTI, a configuration scheduling (CS)-RNTI, a modulation and coding scheme (MCS)-C-RNTI, a system information (SI)-RNTI, a paging (P)-RNTI, a random access (RA)-RNTI, an MSGB-RNTI, a sensing-related RNTI, or all RNTIs except the sensing-related RNTI.

In some implementations, for example, the one or more uplink signals include one or more of an uplink sensing-dedicated signal, an uplink shared channel associated with a specific RNTI, an uplink control channel format 0, an uplink control channel format 1, an uplink control channel format 2, an uplink control channel format 3, uplink control channel format 4, a random access channel, a demodulation reference signal for the uplink shared channel, a demodulation reference signal for the uplink control channel, a phase tracking reference signal, or a sounding reference signal. For example, the specific RNTI includes one or more of the following a C-RNTI, a CS-RNTI, an MCS-C-RNTI, a TC-RNTI, a SP-CSI-RNTI, or a sensing-related RNTI, or all RNTIs except the sensing-related RNTI.

In some implementations, for example, the method further includes transmitting to a second node information indicating a demand for a distance from an object of the sensing detection, and/or information indicating a capability in relation to the sensing detection.

In accordance with another aspect of the disclosure, a method performed by a second node in a wireless communication system is provided. The method includes determining resources associated with sensing detection by a first node, where on the determined resources, one or more downlink signals are not transmitted, and/or one or more uplink signals are not received.

In some implementations, for example, the resource associated with sensing detection by a first node includes a first resource for sensing detection by the first node. The method further includes transmitting configuration information indicating the first resource for sensing detection by the first node to the first node.

In some implementations, for example, the configuration information indicates one or more of positions of time domain resource units for sensing detection by the first node, a number of time domain resource units for sensing detection by the first node, a period for sensing detection by the first node, positions of time domain resource units for sensing detection by the first node in a single period, a number of time domain resource units for sensing detection by the first node in a single period, positions of frequency domain resource units for sensing detection by the first node, a frequency hopping configuration of frequency domain resource units for sensing detection by the first node, where the time domain resource unit includes one or more of a time domain symbol, a slot, or a radio frame, and the frequency domain resource unit includes one or more of a subcarrier, a physical resource block, or a physical resource block group.

In some implementations, for example, the first resource for sensing detection by the first node is determined based on an association between the first resource and resources of the physical signal, where the sensing detection by the first node is based on the physical signal.

In some implementations, for example, the first resource is determined based on one or more of positions of one or more time domain resource units of the first resource being the same as positions of one or more time domain resource units of the physical signal, there being a time interval between the positions of the one or more time domain resource units of the time domain resource of the first resource and the positions of the one or more time domain resource units of the time domain resource of the physical signal, frequency domain resources of the first resource including at least frequency domain resources of the physical signal, the frequency domain resources of the first resource being the same as the frequency domain resources of the physical signal, positions of one or more frequency domain resource units of the first resource being the same as positions of one or more frequency domain resource units of the physical signal, or the frequency domain resources of the first resource including the frequency domain resources of the physical signal and a frequency range of the first resource including at least a frequency range of the frequency domain resources of the physical signal.

In some implementations, for example, the resource associated with sensing detection by the first node includes a second resource, where on the second resource, one or more uplink signals are not received, the second resource is determined based on an association between the second resource and resources of the physical signal, and the sensing detection by the first node is based on the physical signal.

In some implementations, for example, the second resource is determined based on one or more of there being a time interval between positions of one or more time domain resource units of the second resource and positions of one or more time domain resource units of the physical signal, or one or more frequency domain resource units of the second resource being adjacent to the first frequency domain resource unit or the last frequency domain resource unit of the one or more frequency domain resource units of the physical signal.

In some implementations, for example, the one or more downlink signals include one or more of a downlink sensing-dedicated signal, a downlink shared channel associated with a specific radio network temporary identifier (RNTI), a downlink control channel, a downlink control channel associated with a specific RNTI, a downlink control channel in a UE-specific search space (USS), a downlink control channel in a common search space (CSS), a channel state information reference signal (CSI-RS), a synchronization signal, a physical broadcast channel (PBCH), or a synchronization signal block (SSB). For example, the specific RNTI includes one or more of a cell (C)-RNTI, a configuration scheduling (CS)-RNTI, a modulation and coding scheme (MCS)-C-RNTI, a system information (SI)-RNTI, a paging (P)-RNTI, a random access (RA)-RNTI, an MSGB-RNTI, a sensing-related RNTI, or all RNTIs except the sensing-related RNTI.

In some implementations, for example, the one or more uplink signals include one or more of an uplink sensing-dedicated signal, an uplink shared channel associated with a specific RNTI, an uplink control channel format 0, an uplink control channel format 1, an uplink control channel format 2, an uplink control channel format 3, uplink control channel format 4, a random access channel, a demodulation reference signal for the uplink shared channel, a demodulation reference signal for the uplink control channel, a phase tracking reference signal, or a sounding reference signal. For example, the specific RNTI includes one or more of the following a C-RNTI, a CS-RNTI, an MCS-C-RNTI, a TC-RNTI, a SP-CSI-RNTI, or a sensing-related RNTI, or all RNTIs except the sensing-related RNTI.

In some implementations, for example, the method further includes receiving from the first node information indicating a demand for a distance from an object of the sensing detection, and/or information indicating a capability in relation to the sensing detection.

In accordance with another aspect of the disclosure, a method performed by a second node in a wireless communication system is provided. The method includes transmitting a physical signal, and determining resources associated with sensing detection based on the physical signal. On the determined resources, one or more downlink signals are not transmitted, and/or one or more uplink signals are not received.

In some implementations, for example, the resource associated with the sensing detection based on the physical signal includes a third resource for sensing detection of the physical signal, where on the third resource, one or more uplink signals are not received. The method further includes transmitting configuration information to a first node, where the configuration information indicates the third resource for the sensing detection of the physical signal.

In some implementations, for example, the configuration information indicates one or more of positions of time domain resource units for sensing detection of the physical signal, a number of time domain resource units for sensing detection of the physical signal, a period for sensing detection of the physical signal, positions of time domain resource units for sensing detection of the physical signal in a single period, a number of time domain resource units for sensing detection of the physical signal in a single period, positions of frequency domain resource units for sensing detection of the physical signal, a frequency hopping configuration of frequency domain resource units for sensing detection of the physical signal, where the time domain resource unit includes one or more of a time domain symbol, a slot, or a radio frame, and the frequency domain resource unit includes one or more of a subcarrier, a physical resource block, or a physical resource block group.

In some implementations, for example, the resource associated with the sensing detection based on the physical signal includes a third resource for sensing detection of the physical signal. The third resource for the sensing detection of the physical signal is determined based on an association between the third resource and resources of the physical signal.

In some implementations, for example, the third resource is determined based on one or more of positions of one or more time domain resource units of the third resource being the same as positions of one or more time domain resource units of the physical signal, there being a time interval between the positions of the one or more time domain resource units of the time domain resource of the third resource and the positions of the one or more time domain resource units of the time domain resource of the physical signal, frequency domain resources of the third resource including at least frequency domain resources of the physical signal, the frequency domain resources of the third resource being the same as the frequency domain resources of the physical signal, positions of one or more frequency domain resource units of the third resource being the same as positions of one or more frequency domain resource units of the physical signal, or the frequency domain resources of the third resource including the frequency domain resources of the physical signal and having a frequency range wider than a frequency range of the frequency domain resources of the physical signal.

In some implementations, for example, the method further includes receiving an echo signal for the physical signal on the third resource.

In some implementations, for example, the resource associated with sensing detection based on the physical signal includes a fourth resource, where on the fourth resource, one or more downlink signals are not transmitted. The fourth resource is determined based on an association between the fourth resource and resources of the physical signal.

In some implementations, for example, the fourth resource is determined based on one or more of there being a time interval between positions of one or more time domain resource units of the fourth resource and positions of one or more time domain resource units of the physical signal, or one or more frequency domain resource units of the fourth resource being adjacent to the first frequency domain resource unit or the last frequency domain resource unit of the one or more frequency domain resource units of the physical signal.

In some implementations, for example, the one or more downlink signals include one or more of a downlink sensing-dedicated signal, a downlink shared channel associated with a specific radio network temporary identifier (RNTI), a downlink control channel, a downlink control channel with the specific RNTI, a downlink control channel in a UE-specific search space (USS), a downlink control channel in a common search space (CSS), a channel state information reference signal (CSI-RS), a synchronization signal, a physical broadcast channel (PBCH), or a synchronization signal block (SSB). The specific RNTI includes one or more of a cell (C)-RNTI, a configuration scheduling (CS)-RNTI, a modulation and coding scheme (MCS)-C-RNTI, a system information (SI)-RNTI, a paging (P)-RNTI, a random access (RA)-RNTI, an MSGB-RNTI, a sensing-related RNTI, or all RNTIs except the sensing-related RNTI.

In some implementations, for example, the one or more uplink signals include one or more of an uplink sensing-dedicated signal, an uplink shared channel associated with a specific RNTI, an uplink control channel format 0, an uplink control channel format 1, an uplink control channel format 2, an uplink control channel format 3, uplink control channel format 4, a random access channel, a demodulation reference signal for the uplink shared channel, a demodulation reference signal for the uplink control channel, a phase tracking reference signal, or a sounding reference signal. For example, the specific RNTI includes one or more of the following a C-RNTI, a CS-RNTI, an MCS-C-RNTI, a TC-RNTI, a SP-CSI-RNTI, or a sensing-related RNTI, or all RNTIs except the sensing-related RNTI.

In some implementations, for example, the method further includes receiving from the first node information indicating a demand for a distance from an object of the sensing detection, and/or information indicating a capability in relation to the sensing detection.

In accordance with another aspect of the disclosure, a first node in a wireless communication system is provided. The first node includes a transceiver, and a controller coupled with the transceiver and configured to perform one or more operations of the foregoing method that can be performed by the first node.

In accordance with another aspect of the disclosure, a second node in a wireless communication system is provided. The second node includes a transceiver, and a controller coupled with the transceiver and configured to perform one or more operations of the foregoing method that can be performed by the second node.

In accordance with another aspect of the disclosure, a computer-readable storage medium on which one or more computer programs are stored is provided. The one or more computer programs, when being executed by one or more processors, performs any one of the methods described above.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the drawings, in which:

FIG. 1 illustrates a schematic diagram of a wireless network according to an embodiment of the disclosure;

FIG. 2A illustrates wireless transmission and reception paths according to various embodiments of the disclosure;

FIG. 2B illustrates wireless transmission and reception paths according to various embodiments of the disclosure;

FIG. 3A illustrates a user equipment (UE) according to an embodiment of the disclosure;

FIG. 3B illustrates gNodeB (gNB) according to an embodiment of the disclosure;

FIG. 4 illustrates a schematic diagram of time domain resource allocation/assignment of a first physical resource according to an embodiment of the disclosure;

FIG. 5 illustrates a schematic diagram of frequency domain resource allocation/assignment of a first physical resource according to an embodiment of the disclosure;

FIG. 6 illustrates a schematic diagram of time domain resource allocation/assignment of a second physical resource according to an embodiment of the disclosure;

FIG. 7 illustrates a schematic diagram of time domain resource allocation/assignment of a third physical resource according to an embodiment of the disclosure;

FIG. 8 illustrates a schematic diagram of frequency domain resource allocation/assignment of a third physical resource according to an embodiment of the disclosure;

FIG. 9 illustrates a flowchart of a method performed by a first node in a wireless communication system according to an embodiment of the disclosure;

FIG. 10 illustrates a flowchart of a method performed by a first node in a wireless communication system according to an embodiment of the disclosure;

FIG. 11 illustrates a flowchart of a method performed by a second node in a wireless communication system according to an embodiment of the disclosure;

FIG. 12 illustrates a flowchart of a method performed by a second node in a wireless communication system according to an embodiment of the disclosure;

FIG. 13 illustrates a block diagram of a first node according to an embodiment of the disclosure; and

FIG. 14 illustrates a block diagram of a second node according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In order to meet the increasing demand for wireless data communication services since the deployment of 4^{th} generation (4G) communication systems, efforts have been made to develop improved 5G or pre-5G communication systems. Therefore, 5G or pre-5G communication systems are also called “beyond 4G networks” or “post-long term evolution (LTE) systems”.

In order to achieve a higher data rate, 5G communication systems are implemented in higher frequency (millimeter wave (mmWave)) bands, e.g., 60 GHz bands. In order to reduce propagation loss of radio waves and increase a transmission distance, technologies, such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, or the like.

In 5G systems, hybrid frequency shift keying (FSK) and quadrature amplitude modulation (QAM) (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

In order to make the purpose, technical schemes and advantages of the embodiments of the disclosure clearer, the technical schemes of the embodiments of the disclosure will be described clearly and completely with reference to the drawings of the embodiments of the disclosure. Apparently, the described embodiments are a part of the embodiments of the disclosure, but not all embodiments. Based on the described embodiments of the disclosure, all other embodiments obtained by those of ordinary skill in the art without creative labor belong to the protection scope of the disclosure.

Before undertaking the DETAILED DESCRIPTION below, it can be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, and/or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as a read-only memory (ROM), a random access memory (RAM), a hard disk drive, a compact disc (CD), a digital video disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the disclosure. For example, unless otherwise defined, the technical terms or scientific terms used in the disclosure shall have the ordinary meaning understood by those with ordinary skills in the art to which the disclosure belongs.

It should be understood that “first”, “second” and similar words used in the disclosure do not express any order, quantity or importance, but are only used to distinguish different components.

As used herein, any reference to “an example” or “example”, “an implementation” or “implementation”, “an embodiment” or “embodiment” means that particular elements, features, structures or characteristics described in connection with the embodiment is included in at least one embodiment. The phrases “in one embodiment” or “in one example” appearing in different places in the specification do not necessarily refer to the same embodiment.

As used herein, “a portion of” something means “at least some of” the thing, and as such may mean less than all of, or all of, the thing. As such, “a portion of” a thing includes the entire thing as a special case, i.e., the entire thing is an example of a portion of the thing.

As used herein, the term “set” means one or more. Accordingly, a set of items can be a single item or a collection of two or more items.

In this disclosure, to determine whether a specific condition is satisfied or fulfilled, expressions, such as “greater than” or “less than” are used by way of example and expressions, such as “greater than or equal to” or “less than or equal to” are also applicable and not excluded. For example, a condition defined with “greater than or equal to” may be replaced by “greater than” (or vice-versa), a condition defined with “less than or equal to” may be replaced by “less than” (or vice-versa), or the like.

It will be further understood that similar words, such as the term “include” or “comprise” mean that elements or objects appearing before the word encompass the listed elements or objects appearing after the word and their equivalents, but other elements or objects are not excluded. Similar words, such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

The various embodiments discussed below for describing the principles of the disclosure in the patent document are for illustration only and should not be interpreted as limiting the scope of the disclosure in any way. Those skilled in the art will understand that the principles of the disclosure can be implemented in any suitably arranged wireless communication system. For example, although the following detailed description of the embodiments of the disclosure will be directed to LTE and/or 5G communication systems, those skilled in the art will understand that the main points of the disclosure can also be applied to other communication systems with similar technical backgrounds and channel formats with slight modifications without departing from the scope of the disclosure. The technical schemes of the embodiments of the application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5^{th} generation (5G) systems or new radio (NR) systems, or the like. In addition, the technical schemes of the embodiments of the application can be applied to future-oriented communication technologies.

Hereinafter, the embodiments of the disclosure will be described with reference to the accompanying drawings. It should be noted that the same reference numerals in different drawings will be used to refer to the same elements already described.

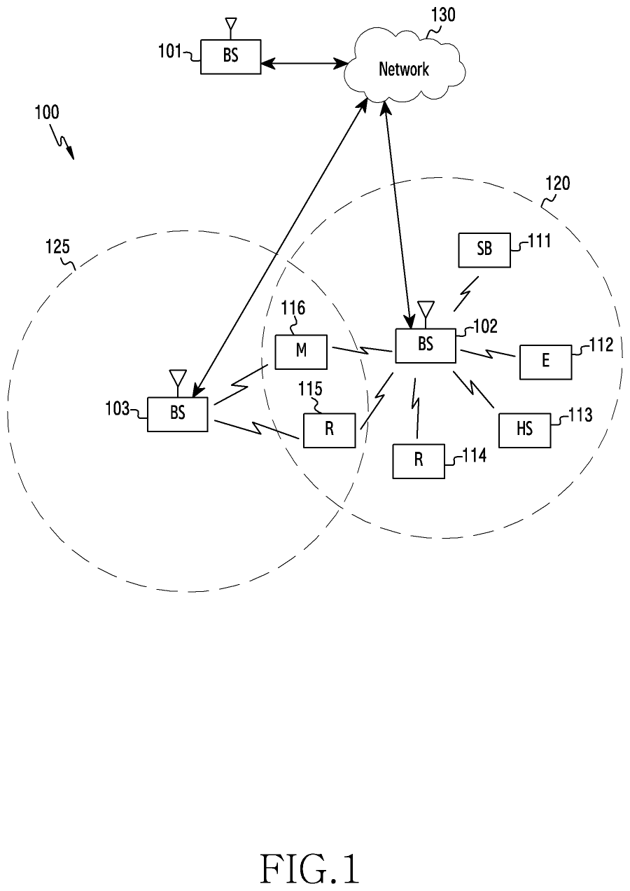

The following FIGS. 1, 2A, 2B, 3A, and 3B describe various embodiments implemented by using orthogonal frequency division multiplexing (OFDM) or orthogonal frequency division multiple access (OFDMA) communication technologies in wireless communication systems. The descriptions of FIGS. 1, 2A, 2B, 3A, and 3B do not mean physical or architectural implications for the manner in which different embodiments may be implemented. Different embodiments of the disclosure may be implemented in any suitably arranged communication systems.

FIG. 1 illustrates a wireless network according to an embodiment of the disclosure.

Referring to FIG. 1, an embodiment of a wireless network 100 shown in FIG. 1 is for illustration only. Other embodiments of the wireless network 100 can be used without departing from the scope of the disclosure.

The wireless network 100 includes a gNodeB (gNB) 101, a gNB 102, and a gNB 103. gNB 101 communicates with gNB 102 and gNB 103. gNB 101 also communicates with at least one Internet protocol (IP) network 130, such as the Internet, a private IP network, or other data networks.

Depending on a type of the network, other well-known terms, such as “base station (BS)” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms, such as “mobile station”, “user station”, “remote terminal”, “wireless terminal” or “user apparatus” can be used instead of “user equipment” or “UE”. For example, the terms “terminal”, “user equipment” and “UE” may be used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of user equipment (UEs) within a coverage area 120 of gNB 102. The first plurality of UEs include a UE 111, which may be located in a small business (SB), a UE 112, which may be located in an enterprise (E), a UE 113, which may be located in a wi-fi hotspot (HS), a UE 114, which may be located in a first residence (R), a UE 115, which may be located in a second residence (R), a UE 116, which may be a mobile device (M), such as a cellular phone, a wireless laptop computer, a wireless personal digital assistant (PDA), or the like. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, long term evolution (LTE), long term evolution advanced (LTE-A), WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described below, one or more of gNB 101, gNB 102, and gNB 103 include a two dimensional (2D) antenna array as described in embodiments of the disclosure. In some embodiments, one or more of gNB 101, gNB 102, and gNB 103 support codebook designs and structures for systems with 2D antenna arrays. Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

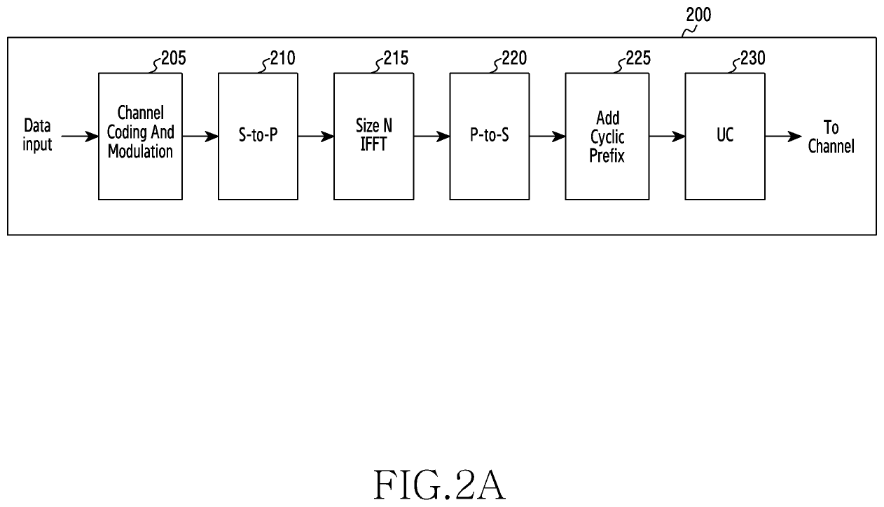

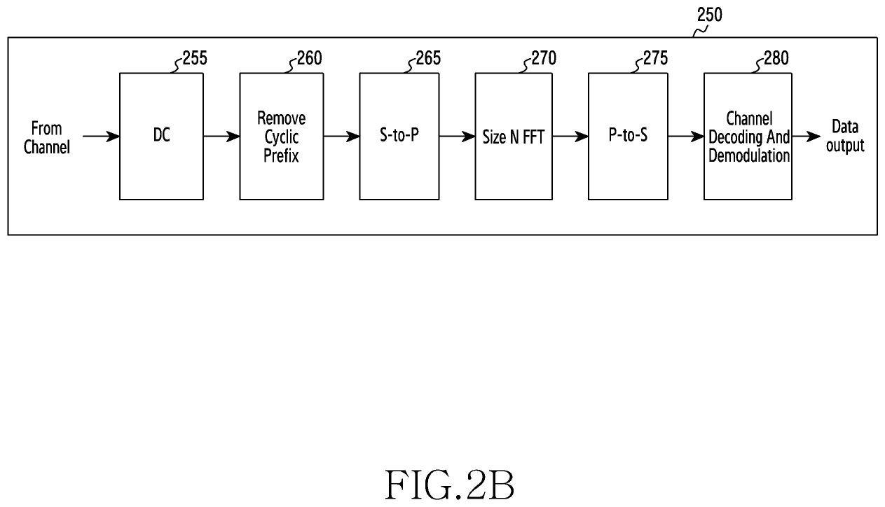

FIGS. 2A and 2B illustrate a wireless transmission and reception paths according to various embodiments of the disclosure.

Referring to FIGS. 2A and 2B, a transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the disclosure.

The transmission path 200 includes a channel coding and modulation block 205, a serial-to-parallel (S-to-P) block 210, a size N inverse fast Fourier transform (IFFT) block 215, a parallel-to-serial (P-to-S) block 220, a cyclic prefix addition block 225, and an up-converter (UC) 230. The reception path 250 includes a down-converter (DC) 255, a cyclic prefix removal block 260, a serial-to-parallel (S-to-P) block 265, a size N fast Fourier transform (FFT) block 270, a parallel-to-serial (P-to-S) block 275, and a channel decoding and demodulation block 280.

In the transmission path 200, the channel coding and modulation block 205 receives a set of information bits, applies coding (such as low density parity check (LDPC) coding), and modulates the input bits (such as using quadrature phase shift keying (QPSK) or quadrature amplitude modulation (QAM)) to generate a sequence of frequency-domain modulated symbols. The serial-to-parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time domain output signal. The parallel-to-serial block 220 converts (such as multiplexes) parallel time domain output symbols from the size N IFFT block 215 to generate a serial time domain signal. The cyclic prefix addition block 225 inserts a cyclic prefix into the time domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time domain baseband signal. The serial-to-parallel block 265 converts the time domain baseband signal into a parallel time domain signal. The size N FFT block 270 performs an FFT algorithm to generate N parallel frequency-domain signals. The parallel-to-serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink (DL), and may implement a reception path 250 similar to that for receiving from UEs 111-116 in the uplink (UL). Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as discrete Fourier transform (DFT) and inverse discrete Fourier transform (IDFT) functions. It should be understood that for DFT and IDFT functions, the value of variable N may be any integer (such as 1, 2, 3, 4, or the like), while for FFT and IFFT functions, the value of variable N may be any integer which is a power of 2 (such as 1, 2, 4, 8, 16, or the like).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

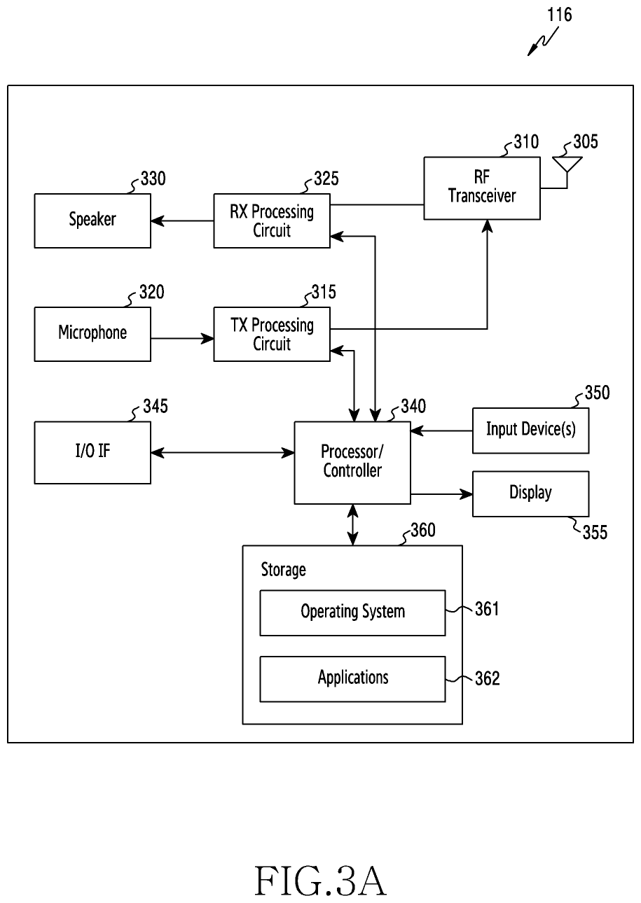

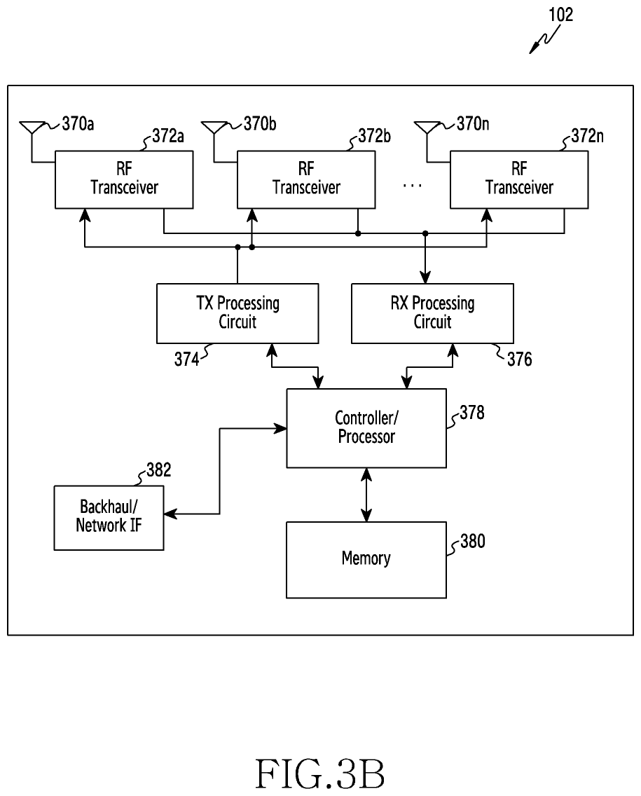

FIG. 3A illustrates a UE according to an embodiment of the disclosure.

Referring to FIG. 3A, the embodiment of UE 116 shown in FIG. 3A is for illustration only, and UEs 111-115 of FIG. 1 can have the same or similar configuration. However, a UE has various configurations, and FIG. 3A does not limit the scope of the disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices, such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

In some embodiments, two or more UE 116 can communicate directly using one or more sidelink channels (e.g., without using a base station as a medium for communication with each other). For example, the UE 116 may communicate using peer-to-peer (P2P) communication, device-to-device (D2D) communication, vehicle-to-everything (V2X) protocol (which may include vehicle-to-vehicle (V2V) protocol, vehicle-to-infrastructure (V2I) protocol, or the like), mesh network, or the like. In this case, the UE 116 may perform scheduling operations, resource selection operations, and/or other operations performed by the base station as described elsewhere herein. For example, the base station may configure the UE 116 via downlink control information (DCI), radio resource control (RRC) signaling, medium access control-control element (MAC-CE) or via system information (e.g., system information block (SIB)).

FIG. 3B illustrates a gNB according to an embodiment of the disclosure.

Referring to FIG. 3B, the embodiment of gNB 102 is for illustration only, and other gNBs of FIG. 1 can have the same or similar configuration. However, a gNB has various configurations, and FIG. 3B does not limit the scope of the disclosure to any specific implementation of a gNB. It should be noted that gNB 101 and gNB 103 can include the same or similar structures as gNB 102.

Referring to FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a blind interference sensing (BIS) process, such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments, the controller/processor 378 supports communication between entities, such as web real-time communications (RTCs). The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

Unless defined differently, all terms (including technical terms or scientific terms) used in this disclosure have the same meaning as those understood by those skilled in the art in this disclosure. Common terms, as defined in dictionaries, are interpreted as having meanings consistent with the context in the relevant technical fields, and should not be interpreted in an idealized or overly formal way unless explicitly defined in this disclosure.

The technical scheme of the embodiments of the disclosure may be applied to various communication systems, such as global system for mobile communications (GSM) systems, code division multiple access (CDMA) systems, wideband code division multiple access (WCDMA) systems, general packet radio service (GPRS), long term evolution (LTE) system, LTE frequency division duplex (FDD) system, LTE time division duplex (TDD), universal mobile telecommunications system (UMTS), worldwide interoperability for microwave access (WiMAX) communication system, 5^{th} generation (5G) system or new radio (NR), or the like. In addition, the technical scheme of the embodiments of the application can be applied to future-oriented communication technologies.

It should be noted that in embodiments of the disclosure, parameters, information or configuration may be pre-configured or predefined or configured by the base station. Therefore, in some cases, parameters, information or configurations can be called predefined parameters, predefined information or predefined configurations, respectively. In some embodiments of the disclosure, the meaning of pre-configuring certain information or parameters in the UE may be interpreted as default information or parameters embedded in the UE when manufacturing the UE, or information or parameters pre-acquired through higher layer signaling (for example, RRC) configuration and stored in the UE, or information or parameters acquired and stored from the base station.

With the advancement of science and technology, there are more and more diverse communication devices. In addition to traditional mobile phones, computers and other devices, such communication devices may also include mobile robots, such as autonomous vehicles and drones. Generally, this type of mobile devices need to have the capability of positioning itself or being positioned with a high accuracy, in order to accurately identify and react to the current situation. For example, they need to have the positioning capability similar to that provided by radar technologies. This may be achieved directly by equipping the communication device with a radar module. However, with the gradual development of the working band of a communication system to a higher band in recent years, the communication band is gradually approaching the radar band, resulting in an inevitable interference and a resource conflict between a communication system and a radar system. To address this issue, it has been considered to integrate a communication device and a radar into a single system, called a communication-sensing integration technology, to further enhance functions of the communication system and improve the spectral efficiency. At present, both the industry and the academia have regarded the communication-sensing integration as one of the key technologies of future communication systems.

A core concept of communication-sensing integration is to use a same set of hardware devices to sense the surrounding environment at as little resource overhead as possible on the premises of ensuring basic communication functions. The sensing includes sensing a distance, an orientation, a speed or even a type of an object or subject in the surrounding environment. Different from the technology of positioning an accessed terminal in a traditional communication system, the communication-sensing integration technology may also sense a variety of information of an object or subject that has not accessed, which greatly increases the capability of a communication system to dynamically adjust (provide scheduling, beam management, early warning of access terminals, and/or the like) the working state thereof according to the surrounding environment.

At present, the most widely used communication systems are systems based on third generation partnership project (3GPP) protocols, such as 4G communication systems, such as LTE and LTE-A systems, and 5G communication systems, such as NR systems, where the signal waveforms used in these communication systems are waveforms modulated based on OFDM. Studies have shown that a communication signal based on an OFDM waveform may perform better as a sensing signal. Therefore, it is feasible to consider adding a sensing function to an existing 4G/5G communication system to realize the integration of communication and sensing. To integrate a sensing function into a communication system, the key is that a receiver of an integrated sensing and communication (ISAC) node (referred to as ISAC node in embodiments of the disclosure) needs to support detection of an echo of the sensing signal, that is, echo signal detection, where the echo refers to a process where the sensing signal transmitted by the ISAC node, after reaching a target object, is reflected back to the receiving end of the ISAC node by a surface of the target object. After receiving the echo signal, the ISAC node processes (detects, estimates, and/or the like) the signal, and obtains a sensing result, such as a distance between the target object and the ISAC node, a radial velocity and an angular velocity of the target object. The detection process described above is actually a process of receiving, detecting and estimating a signal. It is foreseeable that in order to improve the sensing performance and accurately estimate a distance, speed, and/or the like of a target object, it is necessary to consider an impact of transmission and/or reception of a communication signal on detection of an echo signal on time domain resources and/or frequency domain resources. For example, When the ISAC node is a base station, the base station may transmit a downlink signal for sensing and detect an echo signal of the downlink signal in a sensing detection window. At this time, if an uplink signal may be received in the sensing detection window, detection of the echo signal may be interfered by the uplink signal, which further affect the performance of the sensing detection, especially when frequency domain resources of the uplink signal overlap or partially overlap with frequency domain resources of the downlink sensing signal. Therefore, in an ISAC system, it demands prompt solution to ensure that detection of an echo is not interfered by transmission of a communication signal.

According to embodiments of the disclosure, a method for configuring a physical resource is proposed. The method for configuring a physical resource may include a method for configuring a physical resource for sensing detection. For example, in this method, reception of communication signals configured for other non-sensing purposes is limited or prohibited on the physical resource configured for sensing detection, so as to ensure that an ISAC node may receive an echo signal without interference from other communication signals configured for other non-sensing purposes, thereby improving performance of sensing detection. Additionally or alternatively, the method for configuring a physical resource may include a method for configuring a physical resource for reducing interference in sensing detection. For example, in this method, transmission of communication signals configured for other non-sensing purposes is limited or prohibited on the physical resource configured for reducing interference in sensing detection, so as to reduce interference from other communication signals configured for other non-sensing purposes to a sensing node, thereby improving performance of sensing detection.

In embodiments of the disclosure, a sensing signal may include an uplink sensing signal and/or a downlink sensing signal. For example, an uplink sensing signal may include at least one of an uplink sensing-dedicated signal, an uplink shared channel, an uplink control channel, a sounding reference signal (SRS), a random access channels, and/or the like. For example, a downlink sensing signal may include at least one of a downlink sensing-dedicated signal, a downlink shared channel, a downlink control channel, a channel state information reference signal (CSI-RS), a synchronization signal, a physical broadcast channel (PBCH), a synchronization signal block (SSB), and/or the like. The uplink sensing-dedicated signal may be an uplink physical signal/channel dedicated for purpose of sensing. The downlink sensing-dedicated signal may be a downlink physical signal/channel dedicated for purpose of sensing.

In some implementations, an ISAC node may transmit a physical signal (such as a sensing signal), and/or receive an echo signal based on the physical signal (such as the sensing signal). For example, the echo signal may be an electromagnetic feedback signal generated through transmission, scattering, and/or reflection of the physical signal (such as the sensing signal) by a sensing object.

In embodiments of the disclosure, an ISAC node that transmits a physical signal (such as a sensing signal) may include a terminal or a network node (such as a base station). In some examples, a base station acting as an ISAC node transmits a downlink physical channel/signal (such as a downlink sensing signal), and/or a terminal acting as a target object receives or does not receive the downlink physical channel/signal (such as the downlink sensing signal). In some other examples, a terminal acting as an ISAC node transmits an uplink physical channel/signal (such as an uplink sensing signal), and/or a base station acting as a target object receives or does not receive the uplink physical channel/signal. In yet some other examples, a terminal acting as an ISAC node transmits an uplink physical channel/signal (such as an uplink sensing signal), and/or another terminal acting as a target object receives or does not receive the uplink physical channel/signal (such as the uplink sensing signal). The embodiments of the disclosure may be applied to various communication scenarios, including but not limited to a scenario where a base station communicates with a terminal, a scenario where a base station communicates with another base station, or a scenario where a terminal communicates with another terminal. It is noted that in order to facilitate illustration, in some implementations, as an example, a base station may configure a terminal. However, the embodiments of the disclosure are not limited to this. For example, a node for configuring a terminal may be another terminal, a base station or other network nodes.

In embodiments of the disclosure, a resource (or a physical resource) may include a time domain resource and/or a frequency domain resource. In embodiments of the disclosure, a time domain resource may include time domain symbol(s) (such as an OFDM symbol), slot(s), mini-slot(s), or subframe(s), and a frequency domain resource may include channel(s), subchannel(s), carrier(s), subcarrier(s), resource block(s) (RB(s)), a resource element(s) (RE(s)), and/or the like.

In the method for configuring a physical resource according to some embodiments of the disclosure, a terminal determines or obtains configuration of a first physical resource for uplink sensing detection. The terminal may not expect to receive a specific downlink signal on the first physical resource. The uplink sensing detection may refer to a process where the terminal acting as an ISAC node transmits an uplink sensing signal, and receives and detects an echo signal for the uplink sensing signal. Accordingly, the base station may not transmit a specific downlink signal on the first physical resource configured for the terminal, so as to ensure that the terminal is not interfered by the specific downlink signal when performing sensing detection on the physical resource. When the terminal is a sidelink device, the configuration of the first physical resource for the sensing detection by the terminal that is determined or obtained by the terminal may be configured and transmitted by another terminal. For example, accordingly, the other terminal may not transmit a specific downlink signal on the first physical resource configured for the terminal. In addition, when the terminal is a sidelink device, the uplink signal may refer to a signal transmitted by the terminal and received by the other terminal, and the downlink signal may refer to a signal received by the terminal and transmitted by the other terminal. The physical resource may include at least one of a time domain resource or a frequency domain resource.

In some examples, the specific downlink signal may be a specific downlink physical channel and/or a downlink physical signal, for example, one or more of: a downlink sensing-dedicated signal, a downlink shared channel associated with one or more specific radio network temporary identifiers (RNTIs) (such as a cell (C)-RNTI, a configuration scheduling (CS)-RNTI, a modulation and coding scheme (MCS)-C-RNTI, a system information (SI)-RNTI, a paging (P)-RNTI, a random access (RA)-RNTI, an MSGB-RNTI, a sensing-related RNTI, and/or the like) (for example, the downlink shared channel scheduled by the RNTI. Alternatively, for example, the downlink shared channel scheduled by a downlink control channel or downlink control information (DCI) scrambled by the RNTI or with a cyclic redundancy check (CRC) scrambled by the RNTI. Alternatively, for example, the downlink shared channel of which a scrambling sequence is generated according to the RNTI), a downlink control channel, a downlink control channel associated with one or more specific RNTIs (such as a C-RNTI, a CS-RNTI, an MCS-C-RNTI, a SI-RNTI, a P-RNTI, a RA-RNTI, an MSGB-RNTI, a sensing-related RNTI, and/or the like) (for example, the downlink control channel scrambled by the RNTI, or the downlink control channel with a CRC scrambled by the RNTI, or the like), a downlink control channel of a UE-specific search space (USS), a downlink control channel of a common search space (CSS), a CSI-RS, a synchronization signals, a PBCH, an SSB, and/or the like. In embodiments of the disclosure, a sensing-related RNTI may refer to a RNTI related to communication sensing (uplink sensing and/or downlink sensing). For example, the uses of the sensing-related RNTI may include at least one of the following transmission (unicast or broadcast transmission) of sensing-related information/signaling; or transmission (broadcast or unicast transmission) for sensing detection.

In yet some examples, the specific downlink signal may be at least one of the following a downlink shared channel associated with all RNTIs except the sensing-related RNTI, and a downlink control channel associated with all RNTIs except the sensing-related RNTI. Accordingly, the terminal only receives a downlink shared channel associated with the sensing-related RNTI and/or a downlink control channel associated with the sensing-related RNTI on the first physical resource. In an ISAC system, the sensing function may have a higher priority than communication transmission. In order to ensure the sensing function, the terminal only receives the necessary sensing-related information or signaling on the first physical resource for uplink sensing detection, and other communication-related physical channels or physical signals get around the configured uplink physical resource for sensing detection.

In still some examples, the specific downlink signal may be a downlink shared channel scheduled by a specific RNTI (for example, scheduled by a downlink control channel or DCI scrambled by the RNTI), and/or a downlink control channel of a USS. For example, the specific RNTI may be at least one of a C-RNTI, a CS-RNTI, and an MCS-C-RNTI. In an ISAC system, the sensing function may need to be performed on the premises of not affecting the communication function. Therefore, only physical channels or physical signals with lower priority (for example, downlink shared channels associated with the specific RNTI, or the like) in communication may be considered to get around the configured uplink sensing physical resource.

In some implementations, the configuration of the first physical resource for sensing detection that is determined or obtained by the terminal may include configuration information of the first physical resource that is obtained by the terminal through at least one of: a higher layer signaling, a DCI, or a media access control (MAC) control element (CE). The configuration of the first physical resource obtained by the terminal may be periodic or aperiodic. The configuration information of the first physical resource obtained through this method may include or indicate at least one of: position(s) of time domain symbol(s)/slot(s)/radio frame(s) for uplink sensing detection, a number of the time domain symbol(s)/slot(s)/radio frame(s) for uplink sensing detection, position(s) of time domain symbol(s)/slot(s)/radio frame(s) for uplink sensing detection within a single period, a number of time domain symbol(s)/slot(s)/radio frame(s) for uplink sensing detection in a single period, a period of uplink sensing detection, position(s) of subcarrier(s)/physical resource block(s) (PRB(s))/physical resource block group(s) (RBG(s)) for uplink sensing detection, or frequency hopping-related configuration of subcarrier(s)/PRB(s)/RBG(s) for uplink sensing detection. In some examples, when the configuration of the first physical resource determined or obtained by the terminal is a periodic configuration, the configuration information determined or obtained by the terminal may include at least one of: position(s) of time domain symbol(s)/slot(s)/radio frame(s) for uplink sensing detection within a single period, a number of time domain symbol(s)/slot(s)/radio frame(s) for uplink sensing detection in a single period, or a period of uplink sensing detection.

In yet some other implementations, the determining or obtaining, by the terminal, configuration of the first physical resource for uplink sensing detection may include determining or obtaining, by the terminal, the configuration of the first physical resource based on configuration of a physical resource of the uplink sensing signal. The first physical resource may be associated with the physical resource of the uplink sensing signal. The following describes examples of an association between the first physical resource and the physical resource of the uplink sensing signal.

As an example of the association between the first physical resource and the physical resource of the uplink sensing signal, position(s) of time domain symbol(s) of the first physical resource may be the same as position(s) of time domain symbol(s) of the uplink sensing signal, and/or there is a predetermined or configured time interval between the position(s) of the time domain symbol(s) of the first physical resource and the position(s) of the time domain symbol(s) of the uplink sensing signal. As an example, the terminal may determine or obtain the position(s) of the time domain symbol(s) of the uplink sensing signal, and determine the position(s) of the time domain symbol(s) of the first physical resource, where the position(s) of the time domain symbol(s) of the first physical resource is the same as the position(s) of the time domain symbol(s) of the uplink sensing signal, and/or there is the predetermined or configured time interval between the position(s) of the time domain symbol(s) of the first physical resource and the position(s) of the time domain symbol(s) of the uplink sensing signal. The time domain symbols with the same position may mean that the time domain symbol(s) of the first physical resource and the time domain symbol(s) of the uplink sensing signal are in a same slot and the index of the time domain symbol(s) of the first physical resource is the same as the index of the time domain symbol(s) of the uplink sensing signal. In some examples, there is a predetermined or configured time interval between the position(s) of the time domain symbol(s) of the first physical resource and the position(s) of the time domain symbol(s) of the uplink sensing signal may mean that there is a predetermined or configured difference between index value(s) of the time domain symbol(s) of the first physical resource and index value(s) of the time domain symbol(s) of the uplink sensing signal. For example, assuming that the index value of a time domain symbol of the uplink sensing signal be i₀, then the index value of a time domain symbol of the first physical resource is i₀+δ or mod(i₀+δ, N), where: δ is the predetermined or configured difference, which may be an integer, such as −1, 0, 1, 2, or the like; N represents the maximum index value of the time domain symbol, which is an integer, for example, the number of time domain symbols in a predetermined time (for example, 1 millisecond) minus 1; and mod(.) represents an modulo operation. Additionally or alternatively, there is a predetermined or configured time interval between the position(s) of the time domain symbol(s) of the first physical resource and the position(s) of the time domain symbol(s) of the uplink sensing signal may also mean that when a same sequence of the uplink sensing signal is transmitted in consecutive L (L may be an integer greater than 0) time domain symbols (for example, transmitted in a repetitive manner that, for example, the same sequence is mapped to each of the L time domain symbols), there is a predetermined or configured difference between the index of the time domain symbol of the first physical resource and the index of the lth time domain symbol in the consecutive time domain symbols. In some examples, the value of l is predetermined, for example, 1 or L, that is, the starting symbol or end symbol (which may be referred to as the starting time domain symbol/end time domain symbol of the uplink sensing signal, in embodiments of the disclosure) in the consecutive time domain symbols where the same sequence of uplink sensing signals is transmitted. In other examples, the determining or obtaining, by the terminal, the predetermined or configured difference δ may include at least one of: determining or obtaining, by the terminal, δ predetermined by protocols, obtaining, by the terminal, δ through a higher layer signaling, obtaining, by the terminal, δ through downlink control information, or obtaining, by the terminal, δ through a MAC signaling. The obtained δ may have one or more values.

In some examples, when a number of time domain symbols where the same sequence of the uplink sensing signal is transmitted is one (the sequence of uplink sensing signal is transmitted in a single time domain symbol), the time domain symbol of the first physical resource may lag behind the time domain symbol of the uplink sensing signal (for example, the above δ has a value of an integer greater than 0, such as 1, 2, . . . ). Alternatively, when the time domain symbol where the same sequence of the uplink sensing signal is transmitted is L (L may be an integer greater than 0) time domain symbols (the same sequence of uplink sensing signals is transmitted in L (for example, consecutive) time domain symbols), the time domain symbol of the first physical resource may lag behind the end time domain symbol of the uplink sensing signal (for example, l=L, and the above δ has a value of an integer greater than or equal to 0, such as 1, 2, . . . ). At this time, the terminal may detect an echo of the uplink sensing signal in a time domain symbol that lags behind the time domain symbol where the uplink sensing signal is transmitted, so as to meet the demand of the terminal for sensing a distant object (that is, an object relatively further away from the terminal). In some other examples, the time domain symbol of the first physical resource may be several symbols ahead of the time domain symbol of the uplink sensing signal (for example, the above δ has a value of a negative integer, such as −1, −2, . . . ). Since the uplink transmission of the terminal may be earlier than the downlink reception (referred to as timing advance), the starting time of the corresponding uplink time domain symbol (for example, with a same index) is earlier than the starting time of the downlink time domain symbol. When the timing advance is larger, the echo signal of a closer sensing target may reach the receiving end of an ISAC node before the starting time of the corresponding downlink time domain symbol (for example, with a same index), so the performance of sensing the closer target object can be guaranteed, because the time domain symbol of the first physical resource is several symbols ahead of the time domain symbol of the uplink sensing signal.

In some examples, a number of the time domain symbols of the first physical resource may be configured as one or more than one. For example, the above δ may include one or more values. Taking the case where the same sequence of uplink sensing signal is transmitted in a single time domain symbol as an example, the number of the time domain symbol of the first physical resource may be configured as one, for example, the time domain symbol of the first physical resource is a time domain symbol where the uplink sensing signal is transmitted (δ=0). As another example, the first physical resource may be configured as multiple consecutive time domain symbols (that is, multiple values of δ are consecutive integers), such as a time domain symbol where the uplink sensing signal is transmitted and another time domain symbol that is adjacent to and temporally precedes the symbol (δ=−1,0).

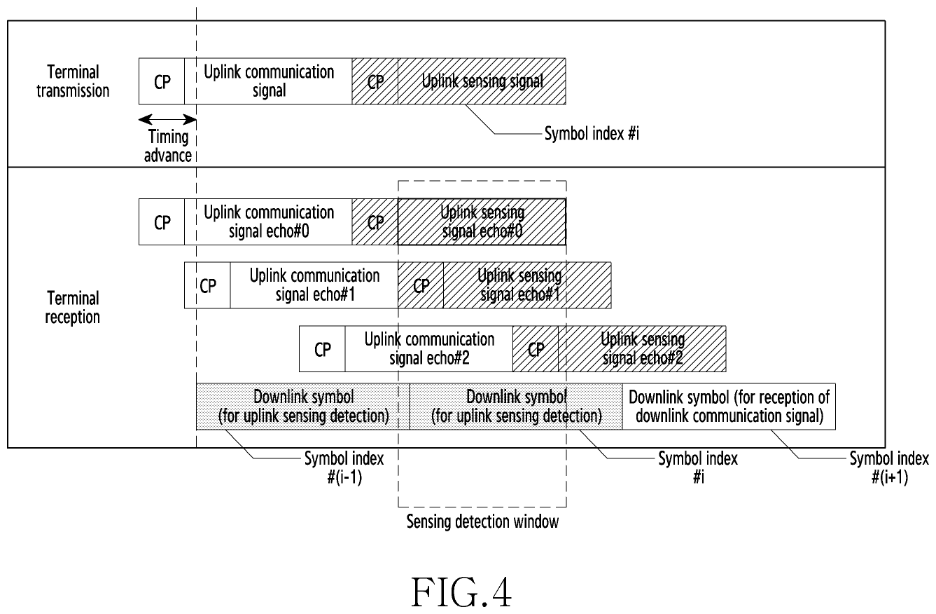

FIG. 4 illustrates a schematic diagram of time domain resource allocation/assignment of the first physical resource according to an embodiment of the disclosure. The terminal may determine or obtain consecutive time domain symbols of the first physical resource (downlink symbols for uplink sensing detection in FIG. 4).

Referring to FIG. 4, the terminal acts as an ISAC node, and the uplink sensing signal is transmitted in the uplink time domain symbol with an index #i, where the uplink transmission has a configured timing advance relative to the starting of the receiving in the downlink symbol with the same index. As the uplink transmission has a configured timing advance relative to the starting of the reception in the downlink symbol with the same index, an echo signal of a closer target (that is, a target object relatively closer from the terminal) for the uplink sensing signal in symbol index #i is received in a downlink symbol with an index earlier than symbol index #i. In this case, in order to ensure the accuracy of sensing the closer target, in addition to the downlink symbol with symbol index #i (δ=0), a downlink symbol with symbol index #i−1 (δ=−1) is also configured as the time domain symbol of the first physical resource. In this way, the terminal may perform the sensing detection on multiple time domain symbols of the first physical resource, so it can determine different target objects at different distances, thereby expanding the sensing distance.

As another example of the association between the first physical resource and the physical resource of the uplink sensing signal, frequency domain resource(s) of the first physical resource may include at least frequency domain resource(s) of the uplink sensing signal. For example, the terminal may determine or obtain the frequency domain resource(s) of the uplink sensing signal, and determine the frequency domain resource(s) of the first physical resource based on the frequency domain resource(s) of the uplink sensing signal, where the frequency domain resource(s) of the first physical resource includes at least the frequency domain resource(s) of the uplink sensing signal.

In some examples, the frequency domain resource(s) of the first physical resource may be the same as the frequency domain resource(s) of the uplink sensing signal. For example, the index of subcarrier(s) for uplink sensing detection may be the same as the index of the subcarrier(s) of the uplink sensing signal. This design has a small frequency domain overhead, which may be suitable for frequency domain sensing detection. For example, the terminal with synchronized uplink and downlink timing (the terminal relatively closer to the base station, and/or the like) may consider using this type of frequency domain sensing detection. At this time, the uplink sensing detection may only be performed on a subcarrier configured for transmission of an uplink sensing signal, without interference from a downlink communication signal.

In some other examples, the frequency domain resource(s) of the first physical resource may include and have a range wider than that of the frequency domain resource(s) of the uplink sensing signal. The frequency domain resource(s) of the uplink sensing signal may be a part of the frequency domain resource(s) of the first physical resource. For example, the frequency domain resource for uplink sensing detection may be a continuous band in frequency domain, including all subcarriers of the uplink sensing signal, such as a bandwidth part (BWP)/carrier where the uplink sensing signal is located. This design may be suitable for time domain sensing detection. For example, the terminal with different uplink and downlink timing (the terminal relatively further away from the base station, and/or the like) may consider using this type of time domain sensing detection. At this time, the terminal acting as the ISAC node receives a time domain signal of an echo for the uplink sensing signal, where the time domain signal has a same frequency range as a radio frequency frontend analog filter in the ISAC node that is configured for sensing detection. As the frequency range of the analog filter depends on hardware implementations, the frequency domain is continuous and the bandwidth cannot be dynamically adjusted (for example, the analog filter may be designed to have a bandwidth matching a BWP bandwidth/a carrier bandwidth). Accordingly, the frequency domain resource(s) of the first physical resource may need to match the frequency range of the analog filter.

When the frequency domain resource(s) of the first physical resource is/are the same as the frequency domain resource(s) of the uplink sensing signal, that is, a subcarrier for uplink sensing detection has a same index as a subcarrier of the uplink sensing signal, the terminal may perform the uplink sensing detection while receiving a downlink physical channel/physical signal in a same time domain symbol at the same time, where the subcarrier for uplink sensing detection has an index value of an even number, and the subcarrier of the downlink physical channel/physical signal has an index value of an odd number; or the subcarrier for uplink sensing detection has an index value of an odd number, and the subcarrier of the downlink physical channel/physical signal has an index value of an even number. Accordingly, in a same time domain symbol, the uplink sensing signal is multiplexed with the downlink physical channel/physical signal, where the subcarrier of the uplink sensing signal has an index value of one of even number and odd number, and the subcarrier of the downlink physical channel/physical signal has an index value of the other one of even number and odd number. In a specific example, the subcarrier of the uplink sensing signal (the subcarrier for uplink sensing detection) has an index value of 0, 2, 4, 6 . . . , and the subcarrier of the downlink physical channel/physical signal has an index value of 1, 3, 5, 7 . . . . In another specific example, the subcarrier of the uplink sensing signal (the subcarrier for uplink sensing detection) has an index value of 1, 3, 5, 7 . . . , and the subcarrier of the downlink physical channel/physical signal has an index value of 0, 2, 4, 6 . . . . When the ISAC has synchronized uplink and downlink timing (for example, the terminal relatively closer to the base station, and/or the like), this mapping can ensure that a downlink communication time domain signal and an uplink sensing echo time domain signal at the receiving end of the ISAC node do not overlap, thereby ensuring the performance of the sensing detection.

Alternatively, when the frequency domain resource(s) of the first physical resource is/are the same as the frequency domain resource(s) of the uplink sensing signal, that is, the subcarrier for uplink sensing detection has a same index as the subcarrier of the uplink sensing signal, the terminal may perform the uplink sensing detection while receiving a downlink physical channel/physical signal in a same time domain symbol at the same time, where the frequency domain resource(s) of the first physical resource (the frequency domain resource for uplink sensing detection)/the frequency domain resource(s) of the uplink sensing signal and the frequency domain resource(s) of the downlink physical channel/physical signal are staggered in frequency in the same time domain symbol. For example, the differences between index values of adjacent subcarriers for uplink sensing detection may be a power of 2 and greater than 1 (for example, 4), and the difference between the index values of the subcarrier for uplink sensing detection and the subcarrier of the downlink physical channel/physical signal that are adjacent with each other may be a power of 2 and greater than 1 (for example, 2) and less than the difference between index values of adjacent subcarriers for uplink sensing detection.

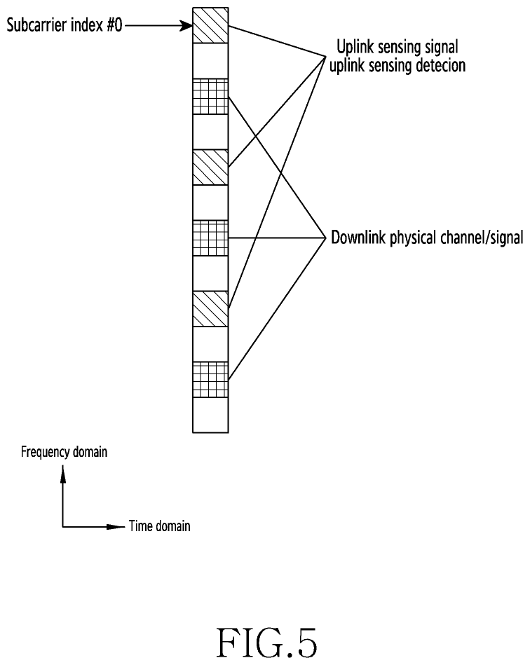

FIG. 5 illustrates a schematic diagram of frequency domain resource allocation/assignment of a first physical resource according to an embodiment of the disclosure.

Referring to FIG. 5, in the time domain symbol, both the subcarrier for uplink sensing detection (the same as the uplink sensing signal) and the subcarrier of the downlink physical channel/physical signal have index values of even numbers, the difference between index values of adjacent subcarriers for uplink sensing detection is 4, the difference between index values of the subcarrier for uplink sensing detection and the subcarrier of the downlink physical channel/physical signal that are adjacent with each other is 2, and in the time domain symbol, subcarriers with index values of odd numbers are not used for any transmission of any uplink physical channel/physical signal and downlink physical channel/physical signal. When the ISAC has synchronized (for example, the terminal relatively closer to the base station, and/or the like) or different (for example, the terminal relatively further away from the base station, and/or the like) uplink and downlink timing, this mapping can ensure that a downlink communication time domain signal and an uplink sensing echo time domain signal at the receiving end of the ISAC node do not overlap, thereby ensuring the performance of the sensing detection.

In the method for configuring a physical resource according to some embodiments of the disclosure, the terminal may determine or obtain configuration of a second physical resource. The terminal may not be expected to transmit a specific uplink signal on the second physical resource. Accordingly, the base station may not receive a specific uplink signal on the second physical resource configured for the terminal. When the terminal is a sidelink device, the configuration of the second physical resource that is determined or obtained by the terminal may be configured and transmitted by the other terminal. For example, accordingly, the other terminal may not receive a specific uplink signal on the second physical resource configured for the terminal. In addition, when the terminal is a sidelink device, the uplink signal may refer to a signal transmitted by the terminal and received by the other terminal, and the downlink signal may refer to a signal received by the terminal and transmitted by the other terminal. Note that the terminal may not only determine or obtain configuration of the first physical resource described above, but also determine or obtain configuration of the second physical resource; or only determine or obtain one of the configuration of the first physical resource and the configuration of the second physical resource. When an uplink communication signal transmitted in a specific physical resource arrives at a sensing target object and an echo signal formed by reflection of the target object falls within a sensing detection resource, there may be interference to the sensing detection by the terminal. Therefore, the specific physical resource may be configured as the second physical resource to ensure the performance of the sensing detection by the terminal. As a result, the second physical resource may be configured to protect the sensing detection and avoid interference to the sensing detection.

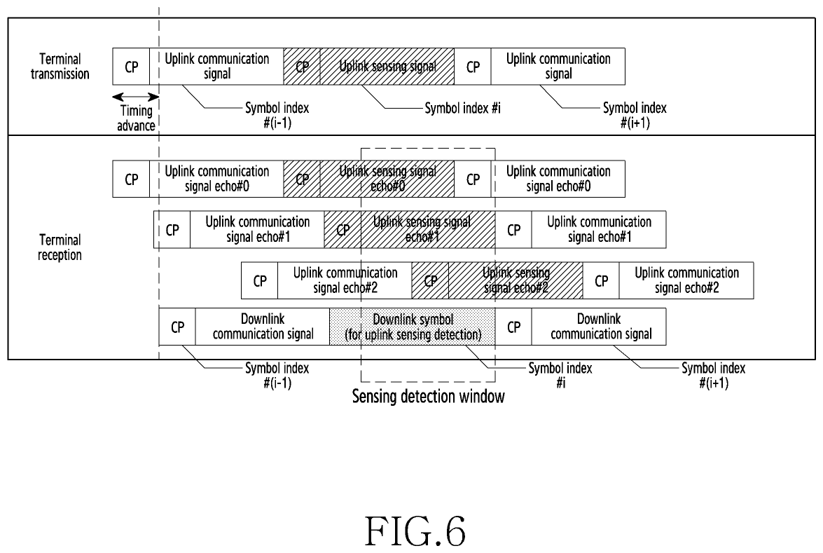

FIG. 6 illustrates a schematic diagram of time domain resource allocation/assignment of a second physical resource according to an embodiment of the disclosure.

Referring to FIG. 6, the terminal transmits an uplink communication signal in symbol #(i+1). Due to the existence of a closer sensing target, the uplink communication signal transmitted in symbol #(i+1) may have an echo (such as an uplink communication signal echo #0 corresponding to symbol #(i+1)) that falls within a time domain receiving window of the sensing detection, which affects detection of uplink sensing signal echo #1 by the terminal, where uplink sensing signal/uplink communication signal echo #0 and uplink sensing signal/uplink communication signal echo #1 may correspond to different sensing target objects. For example, uplink sensing signal/uplink communication signal echo #1 may correspond to a distant sensing target, and uplink sensing signal/uplink communication signal echo #0 may correspond to a closer sensing target. In this case, symbol #(i+1) may be configured as the second physical resource to avoid interference of the uplink transmission in symbol #(i+1) to the sensing detection, thereby ensuring the performance of the sensing detection by the terminal.

According to some implementations of the disclosure, the second physical resource may include at least one of a time domain physical resource or a frequency domain physical resource.

In some examples, the specific uplink signal may be a specific uplink physical channel and/or physical signal, for example, one or more of an uplink sensing-dedicated signal, an uplink shared channel, an uplink shared channel associated with a specific RNTI (for example, a C-RNTI, a CS-RNTI, an MCS-C-RNTI, a TC-RNTI, a SP-CSI-RNTI, or a sensing-related RNTI) (for example, the uplink shared channel scheduled by the RNTI. Alternatively, for example, the uplink shared channel scheduled by a downlink control channel or DCI scrambled by the RNTI or with a CRC scrambled by the RNTI. Alternatively, for example, the uplink shared channel of which a scrambling sequence is generated according to the RNTI), an uplink control channel format 0 (for example, a physical uplink control channel (PUCCH) format 0), an uplink control channel format 1 (for example, a PUCCH format 1), an uplink control channel format 2 (for example, a PUCCH format 2), an uplink control channel format 3 (for example, a PUCCH format 3), an uplink control channel format 4 (for example, a PUCCH format 4), a random access channel, a demodulation reference signal for the uplink shared channel, a demodulation reference signal for the uplink control channel, a phase tracking reference signal, or an SRS.

In yet some examples, the specific uplink signal includes at least an uplink shared channel associated with all RNTIs except the sensing-related RNTI. Accordingly, the terminal only transmits an uplink shared channel associated with the sensing related RNTI on the second physical resource. In an ISAC system, the sensing function may have a higher priority than communication transmission. In order to ensure the sensing function, the terminal only transmits the necessary sensing-related information or signaling on the second physical resource for uplink sensing detection, and other communication-related physical channels or physical signals get around the configured physical resource for uplink sensing detection.

In still some examples, the specific uplink signal may be an uplink shared channel, and/or an uplink control channel of a specific format (for example, a format except the format 0 and format 1). The uplink shared channel may be all uplink shared channels or an uplink shared channel associated with a specific RNTI. As in an ISAC system the sensing function may need to be performed on the premises of not affecting the communication function, only physical channels or physical signals with lower priority in communication may be considered to get around the configured second physical resource.

According to some implementations of the disclosure, the determining or obtaining, by the terminal, configuration of the second physical resource may include determining or obtaining, by the terminal, the configuration of the second physical resource based on the configuration of the physical resource of the uplink sensing signal. For example, the second physical resource may be associated with the physical resource of the uplink sensing signal. The following describes examples of an association between the second physical resource and the physical resource of the uplink sensing signal.

As an example of the association between the second physical resource and the physical resource of the uplink sensing signal, there may be a predetermined time interval between position(s) of time domain symbol(s) of the second physical resource and the position(s) of the time domain symbol(s) of the uplink sensing signal. In an example, the terminal may determine or obtain the position(s) of the time domain symbol(s) of the uplink sensing signal, and determine the position(s) of the time domain symbol(s) of the second physical resource based on the position(s) of the time domain symbol(s) of the uplink sensing signal, where there is the predetermined time interval between the position(s) of the time domain symbol(s) of the second physical resource and the position(s) of the time domain symbol(s) of the uplink sensing signal. For example, the time domain symbol of the second physical resource may be determined as a time domain symbol (which may be referred to as a preceding time domain symbol in embodiments of the disclosure) that is adjacent to and temporally precedes the first time domain symbol of one or more consecutive time domain symbols occupied by the uplink sensing signal, and/or, the time domain symbol of the second physical resource may be determined as a time domain symbol (which may be referred to as subsequent time domain symbol in embodiments of the disclosure) adjacent to and temporally follow the last time domain symbol of the one or more consecutive time domain symbols occupied by the uplink sensing signal. Referring back to FIG. 6, an uplink communication signal transmitted in a preceding time domain symbol may be reflected by a distant sensing target and then fall within a sensing detection window of the terminal (echo #2 in FIG. 6), causing interference. In addition, due to the uplink timing advance, an uplink communication signal transmitted in a subsequent time domain symbol may also have an echo that falls within a sensing detection window of the terminal (echo #0 in FIG. 6), causing interference. Therefore, by configuring a preceding time domain symbol and/or a subsequent time domain symbol as the second physical resource, the performance of the sensing detection by the terminal may be improved. The time domain symbol configured as the second physical resource of the terminal may be one or both of a preceding time domain symbol and a subsequent time domain symbol.

As another example of the association between the second physical resource and the physical resource of the uplink sensing signal, frequency domain resource(s) of the second physical resource may be adjacent to the frequency domain resource(s) of the uplink sensing signal (for example, the last frequency domain unit of one or more frequency domain units occupied by the uplink sensing signal). For example, the terminal may determine or obtain the frequency domain resource(s) of the uplink sensing signal, and determine the frequency domain resource(s) of the second physical resource based on the frequency domain resource(s) of the uplink sensing signal, where the frequency domain resource(s) of the second physical resource may be a band (which may be referred to as a subsequent band in embodiments of the disclosure) adjacent to the last frequency domain unit of the one or more frequency domain units occupied by the uplink sensing signal and with a higher frequency, and/or the frequency domain resource(s) of the second physical resource may be a band (which may be referred to as a preceding band in embodiments of the disclosure) adjacent to the first frequency domain unit of the one or more frequency domain units occupied by the uplink sensing signal and with a lower frequency. The frequency domain unit may be one of: a subcarrier, a physical resource block (PRB), or a physical resource block group (RBG). The bandwidth of the preceding/subsequent band of the second physical resource may be predetermined by protocols or configured. Due to the existence of non-ideal factors, such as an analog device like a power amplifier of the terminal, the uplink communication signal transmitted in an adjacent bandwidth of the uplink sensing signal may generate a non-linear component (such as a higher harmonics component), including a non-linear component leaking into an adjacent band of the uplink sensing signal, causing interference to the sensing detection by the terminal. As the closer to the band of the uplink sensing signal, the higher power of the non-linear component leaking into the band of the uplink sensing signal, interference from leakage of non-linear components of the uplink communication signal may be limited by configuring a band adjacent to the uplink sensing signal as the second physical resource, thereby ensuring the performance of the uplink sensing detection by the terminal.

According to some implementations of the disclosure, before the “determining or obtaining, by the terminal, configuration of the first physical resource for uplink sensing detection” and/or “determining or obtaining, by the terminal, configuration of the second physical resource”, the terminal may also transmit information on capability or request in relation to the sensing. Specifically, the information on capability or request in relation to the sensing may be a demand for a distance from a sensing object by the terminal, for example, whether it needs to sense a target object at a far distance/medium distance/close distance. Alternatively, the information on capability or request in relation to the sensing may also be whether the terminal has a demand or capability of sensing. The terminal may transmit the information on capability or request in relation to the sensing through a higher layer signaling or uplink control information. For example, the base station may configure the first physical resource and/or second physical resource based on the information on capability or request transmitted by the terminal.

In the method for configuring a physical resource according to some embodiments of the disclosure, a terminal may determine or obtain configuration of a third physical resource for downlink sensing detection. The terminal may not transmit a specific uplink signal on the third physical resource. The downlink sensing detection may refer to a process where a base station acting as an ISAC node transmits a downlink sensing signal, and receives and detects an echo signal for the downlink sensing signal. Accordingly, the base station may not receive a specific uplink signal on the third physical resource configured for the terminal, and/or configure the terminal with transmission of a specific uplink signal, so as to ensure that the base station is not interfered by the specific uplink signal when performing downlink sensing detection on the physical resource. When the terminal is a sidelink device, the configuration of the third physical resource for the sensing detection by another terminal (that is, the downlink sensing detection) that is determined or obtained by the terminal may be configured and transmitted by the other terminal. For example, accordingly, the other terminal may not receive a specific uplink signal on the third physical resource configured for the terminal. In addition, when the terminal is a sidelink device, the uplink signal may refer to a signal transmitted by the terminal and received by other terminal, and the downlink signal may refer to a signal received by the terminal and transmitted by the other terminal. The physical resource may include at least one of a time domain resource or a frequency domain resource.

In some examples, the specific uplink signal may be a specific uplink physical channel and/or physical signal, for example, may be one or more of: an uplink sensing-dedicated signal, an uplink shared channel, an uplink shared channel associated with a specific RNTI (for example, a C-RNTI, a CS-RNTI, an MCS-C-RNTI, a TC-RNTI, a SP-CSI-RNTI, or a sensing-related RNTI) (for example, the uplink shared channel scheduled by the RNTI. Alternatively, for example, the uplink shared channel scheduled by a downlink control channel or DCI scrambled by the RNTI or with a CRC scrambled by the RNTI. Alternatively, for example, the uplink shared channel of which a scrambling sequence is generated according to the RNTI), an uplink control channel format 0 (for example, a PUCCH format 0), an uplink control channel format 1 (for example, a PUCCH format 1), an uplink control channel format 2 (for example, a PUCCH format 2), an uplink control channel format 3 (for example, a PUCCH format 3), an uplink control channel format 4 (for example, a PUCCH format 4), a random access channel, a demodulation reference signal for the uplink shared channel, a demodulation reference signal for the uplink control channel, a phase tracking reference signal, or a sounding reference signal (SRS).

In yet some examples, the specific uplink signal includes at least an uplink shared channel associated with all RNTIs except the sensing-related RNTI. Accordingly, the terminal only transmits an uplink shared channel associated with the sensing related RNTI on the third physical resource. In an ISAC system, the sensing function may have a higher priority than communication transmission. In order to ensure the sensing function, the terminal only transmits the necessary sensing-related information or signaling on the third physical resource for downlink sensing detection, and other communication-related physical channels or physical signals get around the configured physical resource for downlink sensing detection.

In still some examples, the specific uplink signal may be an uplink shared channel, and/or an uplink control channel of a specific format (for example, a format except the format 0 and format 1). The uplink shared channel may be all uplink shared channels or an uplink shared channel associated with a specific RNTI. As in an integrated sensing and communication system (ISAC), the sensing function may need to be performed on the premises of not affecting the communication function, only physical channels or physical signals with lower priority in communication may be considered to get around the physical resource for downlink sensing detection.

In some implementations, the configuration of the third physical resource for downlink sensing detection that is determined or obtained by the terminal may include configuration information of the third physical resource that is obtained by the terminal through at least one of a higher layer signaling, downlink control information, or an MAC CE. The configuration of the third physical resource obtained by the terminal may be periodic or aperiodic. The configuration information of the third physical resource obtained through this method may include at least one of position(s) of time domain symbol(s)/slot(s)/radio frame(s) for downlink sensing detection, a number of time domain symbols/slots/radio frames for downlink sensing detection, position(s) of time domain symbol(s)/slot(s)/radio frame(s) for downlink sensing detection within a single period, a number of time domain symbols/slots/radio frames for downlink sensing detection in a single period, a period of downlink sensing detection, position(s) of subcarrier(s)/PRB(s)/RBG(s) for downlink sensing detection, or frequency hopping-related configuration of subcarrier(s)/PRB(s)/RBG(s) for downlink sensing detection. In some examples, when the configuration of the third physical resource determined or obtained by the terminal is a periodic configuration, the configuration information determined or obtained by the terminal may include at least one of: position(s) of time domain symbol(s)/slot(s)/radio frame(s) for downlink sensing detection within a single period, position(s) of time domain symbols/slots/radio frames for downlink sensing detection within a single period, or a period of downlink sensing detection.

In yet some other implementations, the determining or obtaining, by the terminal, configuration of the third physical resource for downlink sensing detection may include determining or obtaining, by the terminal, the configuration of the third physical resource based on configuration of a physical resource of the downlink sensing signal. The third physical resource may be associated with the physical resource of the downlink sensing signal. In some examples, the terminal may receive the downlink sensing signal according to the configuration of the physical resource of the downlink sensing signal (for example, the downlink sensing signal may be a CSI-RS that can be used for purpose of sensing). In this case, when the terminal has a capability to receive and transmit signals at the same time (e.g., full-duplex capability), the third physical resource determined according to the association may overlap with the physical resource of the downlink sensing signal. Otherwise, the third physical resource determined according to the association does not overlap with the physical resource of the downlink sensing signal. In the following description of the method for obtaining the configuration of the third physical resource, it is assumed that the terminal does not receive a downlink sensing signal, or that even the terminal receives the downlink sensing signal, it has the capability to receive and transmit signals at the same time; otherwise, the part that overlaps with the physical resource of the downlink sensing signal may need to be excluded from the configuration of the third physical resource obtained by the terminal. The following describes examples of an association between the third physical resource and the physical resource of the downlink sensing signal.

As an example of the association between the third physical resource and the physical resource of the downlink sensing signal, the position(s) of the time domain symbol(s) of the third physical resource may be the same as the position(s) of the time domain symbol(s) of the downlink sensing signal, and/or there is a predetermined or configured time interval between the position(s) of the time domain symbol(s) of the third physical resource and the position(s) of the time domain symbol(s) of the downlink sensing signal. In an example, the terminal may determine or obtain the position(s) of the time domain symbol(s) of the downlink sensing signal, and determine the position(s) of the time domain symbol(s) of the third physical resource, where the position(s) of the time domain symbol(s) of the third physical resource is the same as the position(s) of the time domain symbol(s) of the downlink sensing signal, and/or there is the predetermined or configured time interval between the position(s) of the time domain symbol(s) of the third physical resource and the position(s) of the time domain symbol(s) of the downlink sensing signal. The time domain symbols with the same position may mean that the time domain symbol(s) of the third physical resource and the time domain symbol(s) of the downlink sensing signal are in a same slot and the index of the time domain symbol(s) of the third physical resource is the same as the index of the time domain symbol(s) of the downlink sensing signal. In some examples, there being the predetermined or configured time interval between the position(s) of the time domain symbol(s) of the third physical resource and the position(s) of the time domain symbol(s) of the downlink sensing signal may mean that there is a predetermined or configured difference between index value(s) of the time domain symbol(s) of the third physical resource and index value(s) of the time domain symbol(s) of the downlink sensing signal. For example, assuming that the index value of the time domain symbol of the downlink sensing signal be j₀, then the index value of the time domain symbol of the third physical resource is j₀+Δ or mod(j₀+Δ, N), where: Δ is the predetermined or configured difference, which may be an integer, such as 0, 1, 2, . . . , or the like; N represents the maximum index value of the time domain symbol, which is an integer, for example, the number of time domain symbols in a predetermined time (for example, 1 millisecond) minus 1; and mod(.) represents an modulo operation. Additionally or alternatively, there being the predetermined or configured time interval between the position(s) of the time domain symbol(s) of the third physical resource and the position(s) of the time domain symbol(s) of the downlink sensing signal may also mean that when a same sequence of the downlink sensing signal is transmitted in consecutive M time domain symbols (for example, transmitted in a repetitive manner that, for example, the same sequence is mapped to each of the M time domain symbols), there is a predetermined or configured difference between the index of the time domain symbol of the third physical resource and the index of the m^{th} time domain symbol in the consecutive time domain symbols. In some examples, the value of m is predetermined, for example, may be 1 or M, that is, the starting symbol or end symbol (which may be referred to as the starting time domain symbol/end time domain symbol of the downlink sensing signal in the disclosure) in the consecutive time domain symbols where the same sequence of downlink sensing signals is transmitted. In other examples, the determining or obtaining, by the terminal, the predetermined or configured difference Δ may be performed through at least one of the following: determining or obtaining, by the terminal, Δ predetermined by protocols, obtaining, by the terminal, Δ through a higher layer signaling, obtaining, by the terminal, Δ through downlink control information, or obtaining, by the terminal, Δ through a MAC signaling. The obtained Δ may have one or more values.

In some examples, when a number of time domain symbols where the same sequence of the downlink sensing signal is transmitted is one (the sequence of the downlink sensing signal is transmitted in a single time domain symbol), the time domain symbol of the third physical resource may lag behind the time domain symbol of the downlink sensing signal (for example, the above Δ has a value of an integer greater than 0, for example, the Δ has value of 1, 2, . . . ). Alternatively, when the number of time domain symbols where the same sequence of the downlink sensing signal is transmitted is M (M may be an integer greater than 0) (the same sequence of downlink sensing signals is transmitted in M (for example, consecutive) time domain symbols), the time domain symbol of the third physical resource may lag behind the end time domain symbol of the downlink sensing signal (for example, m=M, and the above Δ has a value of an integer greater than or equal to 0, such as 1, 2, . . . ). At this time, the base station may detect an echo for the downlink sensing signal in a time domain symbol that lags behind the downlink sensing signal, so as to meet the demand of the base station for sensing a distant object (that is, an object relatively further away from the base station). In some other examples, the number of the time domain symbol of the third physical resource is configured as one or more. For example, the Δ may include one or more values. Taking the case where the same sequence of the downlink sensing signal is transmitted in a single time domain symbol as an example, the third physical resource may be configured as a single time domain symbol, for example, the time domain symbol of the third physical resource is the time domain symbol where the downlink sensing signal is transmitted (Δ=0). As another example, the third physical resource may be configured as multiple consecutive time domain symbols (that is, multiple values of Δ are consecutive integers), such as consecutive two time domain symbols (Δ=0,1) from the time domain symbol where the downlink sensing signal is transmitted. In this case, the sensing detection of a distant target object by the base station may be supported.

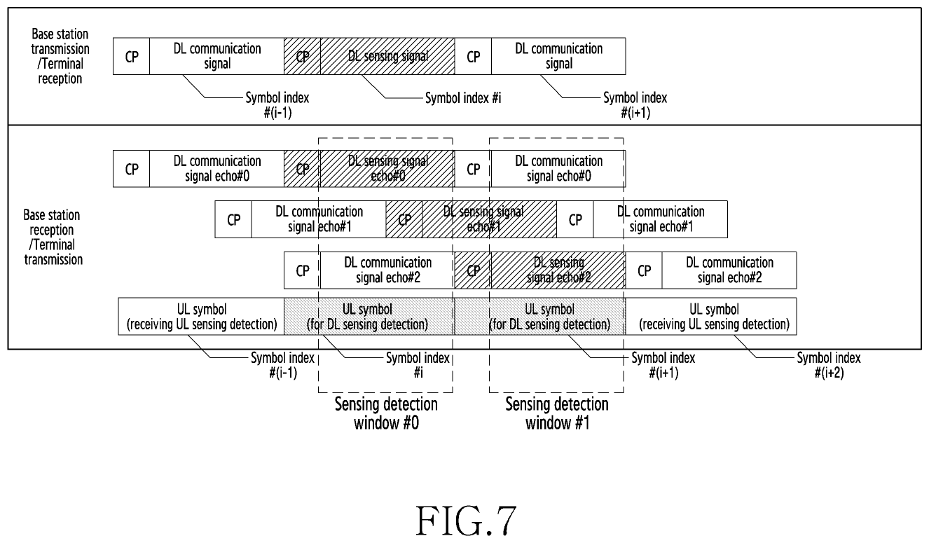

FIG. 7 illustrates a schematic diagram of time domain resource allocation/assignment of a third physical resource according to an embodiment of the disclosure. The terminal may determine or obtain examples of consecutive time domain symbols of the third physical resource (uplink symbols for downlink sensing detection in FIG. 7). In example of FIG. 7, Δ=0,1.

Referring to FIG. 7, the base station acts as an ISAC node, and the downlink sensing signal is transmitted in the downlink time domain symbol with index #i. In this case, the base station is configured with a symbol with index #i (corresponding to Δ=0) and a symbol with index #(i+1) (corresponding to Δ=1) as the time domain symbol of the third physical resource for downlink sensing detection. The base station may receive echo #0 from a close distance target object and echo #1 from a medium distance target object in an uplink symbol with index #i; and receive echo #1 from a mid-distance target object and echo #2 from a far distance target object in an uplink symbol with index #(i+1). The terminal may perform the sensing detection in multiple time domain symbols of the third physical resource to determine three sensing target objects at a close distance, a medium distance, and a far distance, respectively, thereby expanding the sensing distance.

As another example of the association between the third physical resource and the physical resource of the downlink sensing signal, frequency domain resource(s) of the third physical resource may include at least frequency domain resource(s) of the downlink sensing signal. The frequency domain resource(s) of the downlink sensing signal may be a part of the frequency domain resource(s) of the third physical resource. For example, the terminal may determine or obtain the frequency domain resource(s) of the downlink sensing signal, and determine the frequency domain resource(s) of the third physical resource based on the frequency domain resource(s) of the downlink sensing signal, where the frequency domain resource(s) of the third physical resource may include at least the frequency domain resource(s) of the downlink sensing signal.

In some examples, the frequency domain resource(s) of the third physical resource may be the same as the frequency domain resource(s) of the downlink sensing signal. For example, the index of subcarrier(s) for downlink sensing detection may be the same as the index of subcarrier(s) of the downlink sensing signal. This design has a small frequency domain overhead, which may be suitable for frequency domain sensing detection. For example, the base station with synchronized uplink and downlink timing may perform the frequency domain sensing detection. In this case, the downlink sensing detection may only be performed on subcarriers configured for transmission of a downlink sensing signal, without interference from a downlink communication signal.

In some other examples, the frequency domain resource(s) of the third physical resource may include and have a range wider than that of the frequency domain resource(s) of the downlink sensing signal. The frequency domain resource(s) of the uplink sensing signal may be a part of the frequency domain resource(s) of the first physical resource. For example, the frequency domain resource for downlink sensing detection may be a continuous band in frequency domain, including all subcarriers of the downlink sensing signal, such as a bandwidth part (BWP)/carrier where the downlink sensing signal is located. This design may be suitable for time domain sensing detection, for example, in a scenario where the base station is required to perform time domain processing in an implementation. In this case, the base station acting as an ISAC node receives a time domain signal of an echo for the downlink sensing signal, where the time domain signal has a same frequency range as a radio frequency frontend analog filter in the ISAC node that is configured for sensing detection. As the frequency range of the analog filter depends on hardware implementations, the frequency domain is continuous and the bandwidth cannot be dynamically adjusted (for example, the analog filter may be designed to have a bandwidth matching a BWP bandwidth/a carrier bandwidth). Accordingly, the frequency domain resource(s) of the third physical resource may need to match the frequency range of the analog filter.

When the frequency domain resource(s) of the third physical resource is/are the same as the frequency domain resource(s) of the downlink sensing signal, that is, the index(es) of subcarrier(s) for downlink sensing detection is/are the same as the index(es) of subcarrier(s) of the downlink sensing signal, the base station may perform the downlink sensing detection while receiving an uplink physical channel/physical signal (from a terminal) in a same time domain symbol at the same time, where the subcarrier for downlink sensing detection has an index value of an even number, and the subcarrier of the uplink physical channel/physical signal has an index value of an odd number; or the subcarrier for downlink sensing detection has an index value of an odd number, and the subcarrier of the downlink physical channel/physical signal has an index value of an even number. Accordingly, in a same time domain symbol, the downlink sensing signal is multiplexed with the uplink physical channel/physical signal, where the subcarrier of the downlink sensing signal has an index value of one of even number and odd number, and the subcarrier of the uplink physical channel/physical signal has an index value of the other one of even number and odd number. In a specific example, the subcarrier of the downlink sensing signal (the subcarrier for downlink sensing detection) has an index value of 0, 2, 4, 6 . . . , and the subcarrier of the uplink physical channel/physical signal has an index value of 1, 3, 5, 7 . . . . In another specific example, the subcarrier of the downlink sensing signal (the subcarrier for downlink sensing detection) has an index value of 1, 3, 5, 7 . . . , and the subcarrier of the uplink physical channel/physical signal has an index value of 0, 2, 4, 6 . . . . When the ISAC (for example, the base station) has synchronized uplink and downlink timing, this mapping can ensure that a downlink communication time domain signal and an uplink sensing echo time domain signal at the receiving end of the ISAC node do not overlap, thereby ensuring the performance of the sensing detection.

Alternatively, when the frequency domain resource(s) of the third physical resource is/are the same as the frequency domain resource(s) of the downlink sensing signal, that is, the index(es) of the subcarrier(s) for downlink sensing detection is/are the same as the index of the subcarrier(s) of the downlink sensing signal, the base station may perform the downlink sensing detection while receiving an uplink physical channel/physical signal in a same time domain symbol at the same time, where the frequency domain resource(s) of the third physical resource/the frequency domain resource(s) of the downlink sensing signal and the frequency domain resource(s) of the uplink physical channel/physical signal are staggered in frequency in the same time domain symbol. For example, the differences between index values of adjacent subcarriers for downlink sensing detection may be a power of 2 and greater than 1 (for example, 4), and the difference between the index values of the subcarrier for downlink sensing detection and the subcarrier of the downlink physical channel/physical signal that are adjacent with each other may be a power of 2 and greater than 1 (for example, 2) and less than the difference between index values of adjacent carriers for downlink sensing detection.

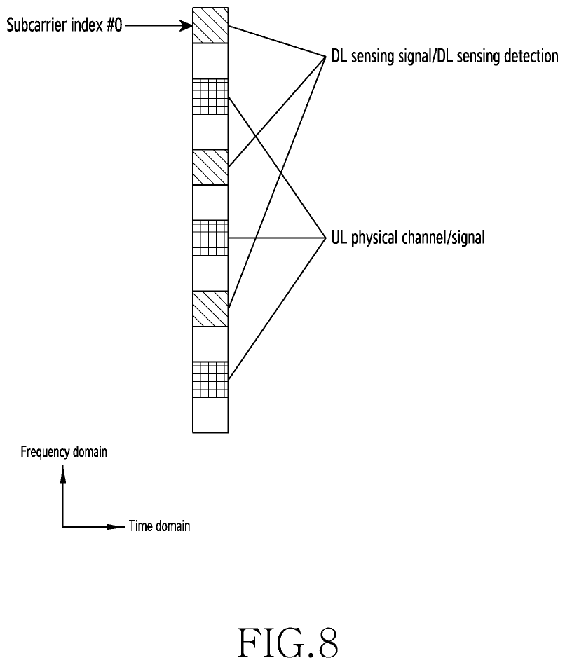

FIG. 8 illustrates a schematic diagram of frequency domain resource allocation/assignment of a third physical resource according to an embodiment of the disclosure.

Referring to FIG. 8, in the time domain symbol, both the subcarrier for downlink sensing detection (the same as the downlink sensing signal) and the subcarrier of the uplink physical channel/physical signal have index values of even numbers, the difference between index values of adjacent carriers for downlink sensing detection is 4, the difference between index values of the carrier for downlink sensing detection and the subcarrier of the downlink physical channel/physical signal that are adjacent with each other is 2, and in the time domain symbol, subcarriers with index values of odd numbers are not used for any transmission of any uplink physical channel/physical signal and downlink physical channel/physical signal.

In the method for configuring a physical resource according to some embodiments of the disclosure, a terminal may obtain configuration of a fourth physical resource. The terminal may not be expected to receive a specific downlink signal on the fourth physical resource. Accordingly, the base station may not transmit a specific downlink signal on the fourth physical resource configured for the terminal. When the terminal is a sidelink device, the configuration of the fourth physical resource that is determined or obtained by the terminal may be configured and transmitted by another terminal. For example, accordingly, the other terminal may not transmit a specific downlink signal on the fourth physical resource configured for the terminal. In addition, when the terminal is a sidelink device, the uplink signal may refer to a signal transmitted by the terminal and received by the other terminal, and the downlink signal may refer to a signal received by the terminal and transmitted by the other terminal. Note that the terminal may not only obtain the configuration of the third physical resource, but also obtain the configuration of fourth physical resource, or only obtain one of the configuration of the third physical resource and the configuration of the fourth physical resource. When a downlink communication signal transmitted in a specific physical resource arrives at a sensing target object and an echo signal formed by reflection of the target object falls within a sensing detection resource, there may be interference to the sensing detection by the base station. The specific physical resource may be configured as the fourth physical resource to ensure the performance of the sensing detection by the base station. As a result, the fourth physical resource may be configured to protect the sensing detection and avoid interference to the sensing detection. For example, referring back to FIG. 7, if the base station transmits a downlink communication signal on a time domain symbol with index #(i+1), due to the existence of a close distance sensing target object, the downlink communication signal transmitted in the time domain symbol with index #(i+1) may generate an echo (for example, downlink communication signal echo #0 corresponding to symbol #(i+1)) that falls within sensing detection window #1, affecting detection of downlink sensing signal echo #1 of a distant target object by the base station. Alternatively, if the base station transmits a downlink communication signal on a time domain symbol with index #(i−1), due to the existence of a distant sensing target object, the downlink communication signal transmitted in the time domain symbol with index #(i−1) may generate an echo (for example, downlink communication signal echo #1 and downlink communication echo #2 corresponding to symbol #(i−1)) that falls within sensing detection window #0, affecting detection of downlink sensing signal echo #1 of a close distance target object by the base station. In this case, the performance of sensing detection by the base station may be ensured by configuring the downlink symbols with symbol index #(i−1) and/or symbol index (i+1) as the fourth physical resource.

According to some implementations of the disclosure, the fourth physical resource may include at least one of a time domain physical resource or a frequency domain physical resource.

In some examples, the specific downlink signal may be a specific downlink physical channel and/or a downlink physical signal, for example, one or more of: a downlink sensing-dedicated signal, a downlink shared channel associated with one or more specific RNTI (such as a C-RNTI, a CS-RNTI, an MCS-C-RNTI, an SI-RNTI, a P-RNTI, a RA-RNTI, an MSGB-RNTI, a sensing-related RNTI, and/or the like) (for example, the downlink shared channel scheduled by the RNTI. Alternatively, for example, the downlink shared channel scheduled by a downlink control channel or downlink control information (DCI) scrambled by the RNTI or with a cyclic redundancy check (CRC) scrambled by the RNTI. Alternatively, for example, the downlink shared channel of which a scrambling sequence is generated according to the RNTI), a downlink control channel, a downlink control channel associated with one or more specific RNTIs (such as a C-RNTI, a CS-RNTI, an MCS-C-RNTI, a SI-RNTI, a P-RNTI, a RA-RNTI, an MSGB-RNTI, a sensing-related RNTI, and/or the like) (for example, the downlink control channel scrambled by the RNTI, or the downlink control channel with a CRC scrambled by the RNTI, or the like), a downlink control channel of a USS, a downlink control channel of a CSS, a CSI-RS, a synchronization signals, a broadcast channel (PBCH), an SSB, and/or the like.

In yet some examples, the specific downlink signal may be at least one of the following: a downlink shared channel associated with all RNTIs except the sensing-related RNTI, and a downlink control channel associated with all RNTIs except the sensing-related RNTI. Accordingly, the terminal only receives a downlink shared channel associated with the sensing-related RNTI and/or a downlink control channel associated with the sensing-related RNTI on the fourth physical resource. In an ISAC system, the sensing function may have a higher priority than communication transmission. In order to ensure the sensing function, the terminal only receives the necessary sensing-related information or signaling on the fourth physical resource for downlink sensing detection, and other communication-related physical channels or physical signals get around the configured uplink physical resource for downlink sensing detection.

In still some examples, the specific downlink signal is a downlink shared channel associated with a specific RNTI (the specific RNTI may be at least one of C-RNTI, CS-RNTI, or MCS-C-RNTI), and/or a downlink control channel of a UE-specific search space. In an integrated sensing and communication system (ISAC), the sensing function may need to be performed on the premises of not affecting the communication function. Therefore, only physical channels or physical signals with lower priority in communication (for example, a downlink shared channel associated with a specific RNTI, and/or the like) may be considered to get around the configured fourth physical resource.

According to some implementations of the disclosure, the determining or obtaining, by the terminal, configuration of the fourth physical resource may include obtaining, by the terminal, the configuration of the fourth physical resource based on configuration of a physical resource of a downlink sensing signal. The fourth physical resource may be associated with the physical resource of the uplink sensing signal. The following describes examples of an association between the fourth physical resource and the physical resource of the downlink sensing signal.

As an example of the association between the fourth physical resource and the physical resource of the downlink sensing signal, there may be a predetermined time interval between position(s) of time domain symbol(s) of the fourth physical resource and position(s) of time domain symbol(s) of the downlink sensing signal. As an example, the terminal may determine or obtain the position(s) of the time domain symbol(s) of the downlink sensing signal, and determine the position(s) of the time domain symbol(s) of the fourth physical resource based on the position(s) of the time domain symbol(s) of the downlink sensing signal, where there is the predetermined time interval between the position(s) of the time domain symbol(s) of the fourth physical resource and the position(s) of the time domain symbol(s) of the downlink sensing signal. For example, the time domain symbol of the fourth physical resource may be a time domain symbol (which may be referred to as a preceding time domain symbol in embodiments of the disclosure) adjacent to and temporally precede the first time domain symbol of one or more consecutive time domain symbols occupied by the downlink sensing signal, and/or, the time domain symbol of the fourth physical resource may be a time domain symbol (which may be referred to as subsequent time domain symbol in embodiments of the disclosure) adjacent to and temporally follow the last time domain symbol of the one or more consecutive time domain symbols occupied by the downlink sensing signal. Referring back to FIG. 7, a downlink communication signal transmitted in a preceding time domain symbol (time domain symbol #(i−1) in FIG. 7) may be reflected by a distant sensing target (echo #1 and echo #2 in FIG. 7) and then fall within sensing detection window #0 of the base station, causing interference. In addition, a downlink communication signal transmitted in a subsequent time domain symbol (time domain symbol #(i+1) in FIG. 7) may also have an echo that falls within sensing detection window #1 of the base station (echo #0 and echo #1 in FIG. 7), causing interference. Therefore, by configuring a preceding time domain symbol and/or a subsequent time domain symbol as the second physical resource, the performance of the sensing detection by the base station may be improved. The time domain symbol configured as the fourth physical resource of the terminal may be one or both of a preceding time domain symbol and a subsequent time domain symbol.

As another example of the association between the fourth physical resource and the physical resource of the downlink sensing signal, frequency domain resource(s) of the fourth physical resource may be adjacent to frequency domain resource(s) of the downlink sensing signal. For example, the frequency domain resource(s) of the fourth physical resource may be a band (which may be referred to as a subsequent band in embodiments of the disclosure) adjacent to the last frequency domain unit of one or more frequency domain units occupied by the downlink sensing signal and with a higher frequency, and/or the frequency domain resource(s) of the fourth physical resource may be a band (which may be referred to as a preceding band in embodiments of the disclosure) adjacent to the first frequency domain unit of the one or more frequency domain units occupied by the downlink sensing signal and with a lower frequency. For example, the terminal determines or obtains the frequency domain resource(s) of the downlink sensing signal, and determines the frequency domain resource(s) of the fourth physical resource based on the frequency domain resource(s) of the downlink sensing signal, where the frequency domain resource(s) of the fourth physical resource may be the subsequent band adjacent to the last frequency domain unit of the one or more frequency domain units occupied by the downlink sensing signal; and/or the frequency domain resource(s) of the fourth physical resource may be the preceding band adjacent to the first frequency domain unit of the one or more frequency domain units occupied by the downlink sensing signal. The frequency domain unit may be one of a subcarrier, a physical resource block (PRB), or a physical resource block group (RBG). The bandwidth of the preceding/subsequent band of the fourth physical resources may be predetermined by protocols or be configured. Due to the existence of non-ideal factors, such as an analog device like a base station power amplifier, the downlink communication signal transmitted in an adjacent bandwidth of the downlink sensing signal may generate a non-linear component (such as a higher harmonics component), including a non-linear component leaking into an adjacent band of the downlink sensing signal, causing interference to the sensing detection by the base station. As the closer to the band of the downlink sensing signal, the higher power of the non-linear component leaking into the band of the downlink sensing signal, interference from leakage of non-linear components of the downlink communication signals may be limited by configuring a band adjacent to the downlink sensing signal as the fourth physical resource, thereby ensuring the performance of the downlink sensing detection by the base station.

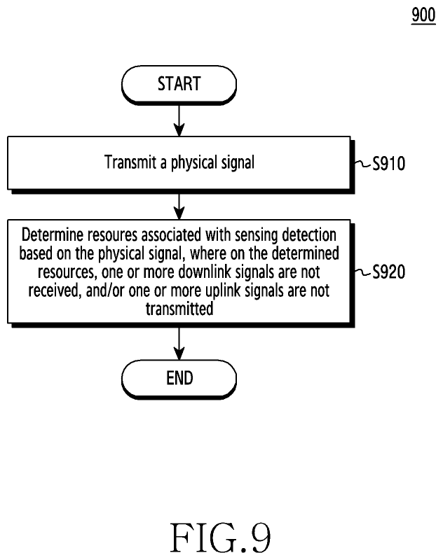

FIG. 9 illustrates a method performed by a first node in a wireless communication system according to an embodiment of the disclosure. For example, the first node may operate as a communication sensing node. For example, the first node may include a terminal or a network node. For example, when the first node is a terminal, a second node communicating with the first node may be a base station or another terminal. Therefore, the method described by referring to FIG. 9 may be used for uplink sensing detection.

Referring to FIG. 9, in operation S910, the first node transmits a physical signal.

In operation S920, the first node determines resource(s) associated with sensing detection based on the physical signal. On the determined resource(s), one or more downlink signals are not received, and/or one or more uplink signals are not transmitted.

In some implementations, the above operations may be performed based on various embodiments described above.

In some implementations, a method 900 further includes the methods or operations in the embodiments described above that may be performed by a communication sensing node.

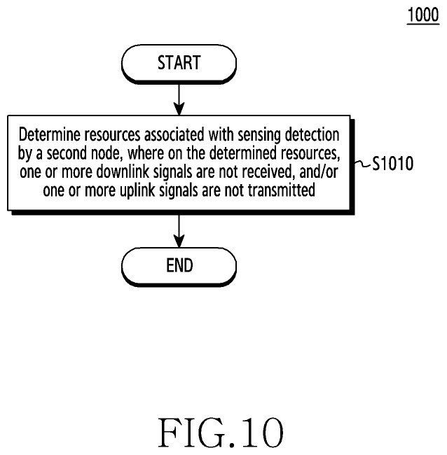

FIG. 10 illustrates a method performed by a first node in a wireless communication system in according to an embodiment of the disclosure. For example, the first node may communicate with a communication sensing node (such as a second node). For example, the first node may include a terminal or a network node. For example, when the first node is a terminal, a second node communicating with the first node may be a base station or another terminal. Therefore, the method described by referring to FIG. 10 may be used for downlink sensing detection.

Referring to FIG. 10, in operation S1010, the first node determines resource(s) associated with sensing detection by the second node, where on the determined resource(s), one or more downlink signals are not received, and/or one or more uplink signals are not transmitted.

In some implementations, the above operations may be performed based on various embodiments described above.

In some implementations, a method 1000 further includes the methods or operations in the embodiments described above that may be performed by a device (such as a terminal) communicating with a communication sensing node (such as a base station acting as the communication sensing node).

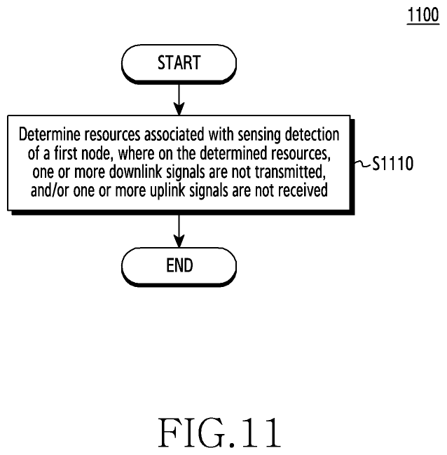

FIG. 11 illustrates a method performed by a second node in a wireless communication system according to an embodiment of the disclosure. For example, the second node may communicate with a communication sensing node (such as a first node). For example, the second node may include a terminal or a network node (such as a base station). For example, when the first node is a terminal, a second node communicating with the first node may be a base station or another terminal. Therefore, the method described by referring to FIG. 11 may be used for uplink sensing detection.

Referring to FIG. 11, in operation S1110, the second node determines resource(s) associated with sensing detection by the first node, where on the determined resource(s), one or more downlink signals are not transmitted, and/or one or more uplink signals are not received.

In some implementations, the above operations may be performed based on various embodiments described above.

In some implementations, a method 1100 may include the methods or operations in the embodiments described above that may be performed by a device (such as a base station) communicating with a communication sensing node (such as a terminal acting as a communication sensing node).

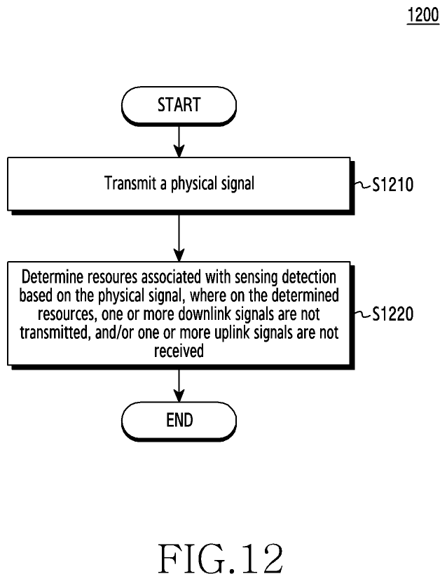

FIG. 12 illustrates a method performed by a second node in a wireless communication system according to an embodiment of the disclosure. For example, the second node acting as a communication sensing node may communicate with a first node. For example, the first node may include a terminal or a network node. For example, when the first node is a terminal, a second node communicating with the first node may be a base station or another terminal. Therefore, the method described by referring to FIG. 10 may be used for downlink sensing detection.

Referring to FIG. 12, in operation S1210, the second node transmits a physical signal.

In operation S1220, the second node determines resource(s) associated with sensing detection based on the physical signal. On the determined resource(s), one or more downlink signals are not received, and/or one or more uplink signals are not transmitted.

In some implementations, the above operations may be performed based on various embodiments described above.

In some implementations, a method 1200 further includes the methods or operations in the embodiments described above that may be performed by a communication sensing node (such as a base station acting as a communication sensing node).

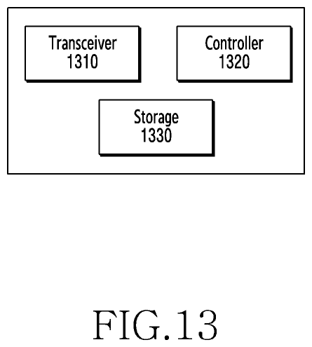

FIG. 13 is a block diagram of a first node (for example, a terminal) according to an embodiment of the disclosure.

Referring to FIG. 13, the terminal includes a transceiver 1310, a controller 1320, and a storage 1330. The controller 1320 may refer to a circuit, an application-specific integrated circuit (ASIC) or at least one processor. The transceiver 1310, the controller 1320 and the storage 1330 are configured to perform operations of the communication sensing node or sensing object described above. Although the transceiver 1310, the controller 1320 and the storage 1330 are shown as separate entities, they may be embodied as a single entity, such as a single chip. Alternatively, the transceiver 1310, the controller 1320, and the storage 1330 may be electrically connected or coupled with each other.

The transceiver 1310 may transmit signals to and receive signals from another network entity (such as a base station).

The controller 1320 may control the terminal to perform functions according to one of the above embodiments. For example, the controller 1320 controls the transceiver 1310 and/or the storage 1330 to perform operations associated with the communication sensing according to various embodiments of the disclosure. According to various embodiments of the disclosure, the terminal may operate as a communication sensing node (e.g., transmitting a sensing signal), and/or operate as a communication sensing object (e.g., receiving a sensing signal), and/or communicate with another network entity (e.g., a base station) that acts as a communication sensing node.

In an embodiment, operations of the terminal may be performed by using the storage 1330 storing the corresponding program codes. Specifically, the terminal may be equipped with the storage 1330 to store program codes to achieve a desired operation. In order to perform the desired operation, the controller 1320 may use at least one processor or central processing unit (CPU) to read and execute the program codes stored in the storage 1330.

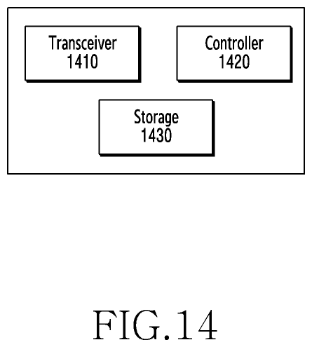

FIG. 14 is a block diagram of a second node (for example, a base station) according to an embodiment of the disclosure.

Referring to FIG. 14, the base station includes a transceiver 1410, a controller 1420, and a storage 1430. The controller 1420 may refer to a circuit, an application-specific integrated circuit (ASIC) or at least one processor. The transceiver 1410, the controller 1420 and the storage 1430 are configured to perform operations of the base station described above. Although the transceiver 1410, the controller 1420 and the storage 1430 are shown as separate entities, they may be embodied as a single entity, such as a single chip. Alternatively, the transceiver 1410, the controller 1420, and the storage 1430 may be electrically connected or coupled with each other.

The transceiver 1410 may transmit signals to and receive signals from another network entity (such as a terminal).

The controller 1420 may control the base station to perform functions according to one of the above embodiments. For example, according to various embodiments of the disclosure, the controller 1420 controls the transceiver 1410 and/or the storage 1430 to perform operations associated with the communication sensing. According to various embodiments of the disclosure, the base station may operate as a communication sensing node (e.g., transmitting a sensing signal), and/or operate as a communication sensing object (e.g., receiving a sensing signal), and/or communicate with another network entity (e.g., a terminal) that acts as a communication sensing node.

In an embodiment, operations of the base station may be performed by using the storage 1430 storing the corresponding program codes. Specifically, the base station may be equipped with the storage 1430 to store program codes to achieve a desired operation. In order to perform the desired operation, the controller 1420 may use at least one processor or central processing unit (CPU) to read and execute the program codes stored in the storage 1430.

Those skilled in the art will understand that the above illustrative embodiments are described herein and are not intended to be limiting. It should be understood that any two or more of the embodiments disclosed herein may be combined in any combination. Furthermore, other embodiments may be utilized and other changes may be made without departing from the spirit and scope of the subject matter presented herein. It will be readily understood that aspects of the disclosure of the disclosure as generally described herein and shown in the drawings may be arranged, replaced, combined, separated and designed in various different configurations, all of which are contemplated herein.

Those skilled in the art will understand that the various illustrative logical blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

The various illustrative logic blocks, modules, and circuits described in this application may be implemented or performed by a general purpose processor, a digital signal processor (DSP), an application specific integrated circuit (ASIC), a field programmable gate array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors cooperating with a DSP core, or any other such configuration.

The steps of the method or algorithm described in this application may be embodied directly in hardware, in a software module executed by a processor, or in a combination thereof. The software module may reside in a RAM memory, a flash memory, a ROM memory, an erasable programmable read only memory (EPROM) memory, an electrically erasable programmable read only memory (EEPROM) memory, a register, a hard disk, a removable disk, or any other form of storage medium known in the art. A storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
transmitting, to a base station (BS), a physical signal;
receiving, from the BS, configuration information indicating a first resource for sensing detection; and
determining the first resource for sensing detection based on the physical signal and the configuration information,
wherein on the first resource, one or more downlink signals are not received.

2. The method of claim 1,
wherein the configuration information indicates at least one of:
positions of time domain resource units for sensing detection,
a number of time domain resource units for sensing detection,
a period for sensing detection,
positions of time domain resource units for sensing detection in a single period,
a number of time domain resource units for sensing detection within a period,
positions of frequency domain resource units for sensing detection, or
a frequency hopping configuration of frequency domain resource units for sensing detection,
wherein the time domain resource unit includes at least one of a time domain symbol, a slot, or a radio frame, and
wherein the frequency domain resource unit includes at least one of a subcarrier, a physical resource block, or a physical resource block group.

3. The method of claim 1, wherein the determining of the first resource for sensing detection includes:
determining the first resource based on an association between the first resource and resources of the physical signal.

4. The method of claim 3, wherein the determining of the first resource based on an association between the first resource and resources of the physical signal includes determining the first resource based on at least one of:
position of at least one time domain resource unit of the first resource being same as position of at least one time domain resource unit of the physical signal;
there being a time interval between the position of the at least one time domain resource unit of the first resource and the position of the at least one time domain resource unit of the physical signal;
frequency domain resources of the first resource including at least frequency domain resources of the physical signal;
the frequency domain resources of the first resource being same as the frequency domain resources of the physical signal;
position of at least one frequency domain resource unit of the first resource being same as position of at least one frequency domain resource unit of the physical signal; or
the frequency domain resources of the first resource including the frequency domain resources of the physical signal and a frequency range of the first resource including at least a frequency range of the frequency domain resources of the physical signal.

5. The method of claim 1, further comprising:
receiving, from the BS, an echo signal for the physical signal on the first resource.

6. A user equipment (UE) in a wireless communication system, the UE comprising:
a transceiver;
a controller connected to the transceiver and configured to:
transmit, to a base station (BS), a physical signal,
receive, from the BS, configuration information indicating a first resource for sensing detection, and
determine the first resource for sensing detection based on the physical signal and the configuration information,
wherein on the first resource, one or more downlink signals are not received.

7. The UE of claim 6,
wherein the configuration information indicates at least one of:
positions of time domain resource units for sensing detection,
a number of time domain resource units for sensing detection,
a period for sensing detection,
positions of time domain resource units for sensing detection in a single period,
a number of time domain resource units for sensing detection within a period,
positions of frequency domain resource units for sensing detection, or
a frequency hopping configuration of frequency domain resource units for sensing detection,
wherein the time domain resource unit includes at least one of a time domain symbol, a slot, or a radio frame, and
wherein the frequency domain resource unit includes at least one of a subcarrier, a physical resource block, or a physical resource block group.

8. The UE of claim 6, wherein the controller is further configured to:
determine the first resource based on an association between the first resource and resources of the physical signal.

9. The UE of claim 8, wherein the controller is further configured to:
determine the first resource based on an association between the first resource and resources of the physical signal by using at least one of:
position of at least one time domain resource unit of the first resource being same as position of at least one time domain resource unit of the physical signal,
there being a time interval between the position of the at least one time domain resource unit of the first resource and the position of the at least one time domain resource unit of the physical signal,
frequency domain resources of the first resource including at least frequency domain resources of the physical signal,
the frequency domain resources of the first resource being same as the frequency domain resources of the physical signal,
position of at least one frequency domain resource unit of the first resource being same as position of at least one frequency domain resource unit of the physical signal, or
the frequency domain resources of the first resource including the frequency domain resources of the physical signal and a frequency range of the first resource including at least a frequency range of the frequency domain resources of the physical signal.

10. The UE of claim 6, wherein the controller is further configured to:
receive, from the BS, an echo signal for the physical signal on the first resource.

11. A method performed by a base station (BS) in a wireless communication system, the method comprising:
receiving, from a user equipment (UE), a physical signal;
determining a first resource for sensing detection based on the physical signal; and
transmitting, to the UE, configuration information indicating the first resource for sensing detection,
wherein on the first resource, one or more downlink signals are not received.

12. The method of claim 11,
wherein the configuration information indicates at least one of:
positions of time domain resource units for sensing detection,
a number of time domain resource units for sensing detection,
a period for sensing detection,
positions of time domain resource units for sensing detection in a single period,
a number of time domain resource units for sensing detection within a period,
positions of frequency domain resource units for sensing detection, or
a frequency hopping configuration of frequency domain resource units for sensing detection,
wherein the time domain resource unit includes at least one of a time domain symbol, a slot, or a radio frame, and
wherein the frequency domain resource unit includes at least one of a subcarrier, a physical resource block, or a physical resource block group.

13. The method of claim 11, wherein the determining of the first resource for sensing detection includes:
determining the first resource based on an association between the first resource and resources of the physical signal.

14. The method of claim 13, wherein the determining of the first resource based on an association between the first resource and resources of the physical signal includes determining the first resource based on at least one of:
position of at least one time domain resource unit of the first resource being same as position of at least one time domain resource unit of the physical signal;
there being a time interval between the position of the at least one time domain resource unit of the first resource and the position of the at least one time domain resource unit of the physical signal;
frequency domain resources of the first resource including at least frequency domain resources of the physical signal;
the frequency domain resources of the first resource being same as the frequency domain resources of the physical signal;
position of at least one frequency domain resource unit of the first resource being same as position of at least one frequency domain resource unit of the physical signal; or
the frequency domain resources of the first resource including the frequency domain resources of the physical signal and a frequency range of the first resource including at least a frequency range of the frequency domain resources of the physical signal.

15. The method of claim 11, further comprising:
transmitting, to the UE, an echo signal for the physical signal on the first resource.

16. A base station (BS) in a wireless communication system, the BS comprising:
a transceiver;
a controller connected to the transceiver and configured to:
receive, from a user equipment (UE), a physical signal,
determine a first resource for sensing detection based on the physical signal, and
transmit, to the UE, configuration information indicating the first resource for sensing detection,
wherein on the first resource, one or more downlink signals are not received.

17. The BS of claim 16,
wherein the configuration information indicates at least one of:
positions of time domain resource units for sensing detection,
a number of time domain resource units for sensing detection,
a period for sensing detection,
positions of time domain resource units for sensing detection in a single period,
a number of time domain resource units for sensing detection within a period,
positions of frequency domain resource units for sensing detection, or
a frequency hopping configuration of frequency domain resource units for sensing detection,
wherein the time domain resource unit includes at least one of a time domain symbol, a slot, or a radio frame, and
wherein the frequency domain resource unit includes at least one of a subcarrier, a physical resource block, or a physical resource block group.

18. The BS of claim 16, wherein the controller is further configured to:
determine the first resource based on an association between the first resource and resources of the physical signal.

19. The BS of claim 18, wherein the controller is further configured to:
determine the first resource based on an association between the first resource and resources of the physical signal by using at least one of:
position of at least one time domain resource unit of the first resource being same as position of at least one time domain resource unit of the physical signal,
there being a time interval between the position of the at least one time domain resource unit of the first resource and the position of the at least one time domain resource unit of the physical signal,
frequency domain resources of the first resource including at least frequency domain resources of the physical signal,
the frequency domain resources of the first resource being same as the frequency domain resources of the physical signal,
position of at least one frequency domain resource unit of the first resource being same as position of at least one frequency domain resource unit of the physical signal, or
the frequency domain resources of the first resource including the frequency domain resources of the physical signal and a frequency range of the first resource including at least a frequency range of the frequency domain resources of the physical signal.

20. The BS of claim 16, wherein the controller is further configured to:
transmit, to the UE, an echo signal for the physical signal on the first resource.
